(19) United States
(12) Patent Application Publication
(10) Pub. No.: US 2014/0196248 A1
(43) Pub. Date: Jul. 17, 2014

(54) DEBRIS COLLECTION DEVICE FOR BAGLESS VACUUM CLEANERS

(71) Applicant: Techtronic Floor Care Technology Limited, Road Town (VG)

(72) Inventors: Jeff Morgan, Pineville, LA (US); Dennis Lamb, Cookeville, TN (US); Steven Myers, Buffalo Valley, TN (US); George V. Hibbs, Cookeville, TN (US)

(73) Assignee: Techtronic Floor Care Technology Limited, Road Town (VG)

(21) Appl. No.: 13/743,291

(22) Filed: Jan. 16, 2013

(51) Int. Cl. A47L 9/10; B23P 19/04; A47L 9/00; A47L 9/16

(52) U.S. Cl. CPC A47L 9/106; A47L 9/1683; B23P 19/04; A47L 9/1691; A47L 9/00
USPC 15/353; 29/426.1; 55/357; 49/386

(57) ABSTRACT

A debris collection device is provided with a controlled tension apparatus for controllable release of accumulated debris from a collective debris release outlet.

### TECHNICAL FIELD

This invention relates to bagless vacuum cleaners and debris collection assemblies used therewith.

### BACKGROUND

Numerous configurations for bagless cleaning devices have been developed that effectively separate debris from an airflow When such cleaning devices are used with respect to a cleaning surface or medium. Such devices include a variety of bagless vacuum cleaners that successfully ensure enhanced suction levels. Inherent in the obviation of bags is the difficulty in disposing collected particulates and debris. Such particulates and debris include, but are not limited to, dust, dirt, fibers, food particles, buttons, small lids and caps (such as bottle caps), fur, hair, epidermis particles and the like.

Certain debris collection devices have been developed for such vacuum cleaners, as is known in the art. Such devices sometimes incorporate dust-collecting chambers (sometimes known as “dirt cups”) that are removable from a vacuum cleaner body for disposal of collected particulates. Rotatable lids disposed along an egress of such debris collection devices can be released for disposal of collected particulates. Depending on their design features, some debris collection devices may incorporate lids that are released upon depression of a release button. Other debris collection devices may, upon application of an opening force to the lid, at least initiate opening thereof. In some designs, a user may have to manually release the lid after commencement of debris disposal, which is often due to impaction of debris collected within a dirt cup. In still other designs, restoration of the lid to its closed position after particulate disposal may also require manual manipulation by the user. In these latter configurations, the user's hands contact collected debris and such debris may be furthermore inhaled to the user's detriment.

Despite these known devices, a need persists to control the release of debris from a debris collection device. For example, many existing devices require superfluous dirt cup articulation structure, have poor functionality or require at least partial handling of collected particulates by users. These deficiencies are overcome, and additional attributes are imparted, by the devices presently disclosed herein.

### SUMMARY

A debris collection device is provided for receipt by a bagless surface cleaning apparatus having a main body positioned intermediate abase suction unit and an apparatus handle. The main body includes a chamber within which the debris collection device is operably supported. The debris collection device includes a debris collection canister that accommodates a centrifugal separation system The debris collection device, together with the centrifugal separation system, defines a course debris collection area and a fine debris collection area within which debris accumulates. A debris collection cover is coupled with the debris collection canister, and a handle is formed on at least one of the debris collection canister and the debris collection cover. The handle is configured to be grasped by a user for removal of the debris collection device from, and replacement of the debris collection device in, the main body. The handle also facilitates carrying of the debris collection device upon removal from the main body. An actuatable flapper is provided at or adjacent a collective debris release outlet from which accumulated debris is released from the course debris collection area and the fine debris collection area. A controlled tension apparatus controls an angular range of movement of the flapper for controllable release of accumulated debris from the collective debris release outlet.

The controlled tension apparatus controls actuation of the flapper among (1) a stationary state in which the flapper obstructs release of debris from the coarse debris collection area and the fine debris collection area; (2) an articulating state in which the flapper traverses a controlled angular range of motion so as to at least partially release debris from at least one of the coarse debris collection area and the fine debris collection area; and (3) a release state in which the flapper permits full release of accumulated debris from the coarse debris collection area and the fine debris collection area.

The flapper may includes a support surface having one or more annular ribs that support a combined weight of the debris collection device and any debris collected in the course debris collection area and the fine debris collection area. The flapper may also include a pedestal having a generally cylindrical side wall depending upwardly from a generally planar floor, with the floor having a collection surface upon which debris accumulates in the coarse debris collection area, and the pedestal terminating in an upper wall extent that cooperates with a fine debris release outlet for releasing the debris accumulated in the fine debris collection area when the flapper is in the stationary state. The flapper may additionally include a generally annular side wall coextensive with the flapper support surface and a flapper seat, with the flapper seat providing a predetermined clearance between the flapper and the collective debris release outlet when the flapper is in the stationary state. A generally annular groove may be provided intermediate the floor and the flapper seat to facilitate insertion and operation of a similarly configured seal member.

The flapper may also incorporate a pinion joint depending from the flapper side wall that effects rotatable coupling of the flapper with the debris collection canister. Such a pinion joint can include one or more pinions, with each pinion having a plurality of similarly sized and shaped detents. In an exemplary flapper embodiment, an aperture is incorporated in the flapper side wall opposite the pinion joint and generally dimensioned for sliding receipt of a flapper latch that is reciprocatingly disposed along the flapper support surface. One or more complementary ribs may depend from the flapper support surface and releasably engage corresponding engagement structure provided in the chamber of the main body.

The controlled tension apparatus can include a rack and pinion assembly that operably joins the flapper to a manually liftable pull lever such that manipulation of the pull lever effects corresponding actuation of the flapper relative to the collective debris release outlet. The pull lever is in operable communication with a pull lever body having a gripping portion that can be readily grasped by a user and an opposed mounting portion for mounting of the pull lever body to the debris collection canister. The pull lever can include a pair of actuation arms extending from a shoulder and terminating in free arm extents, with each actuation arm having a longitudinal aperture that accommodates slidable engagement with a pull lever shaft when the gripping portion of the pull lever body is actuated relative to the debris collection canister.

The rack and pinion assembly may also include at least one actuation gear having a plurality of gear teeth engageable with one or more recessed teeth provided, in an actuation gear aperture defined at each free arm extent A rack can be provided that has an elongate rack body interposed between an upper rack portion positioned adjacent the debris collection cover and a lower rack portion positioned adjacent the collective debris release outlet. The upper rack portion may have bifurcations joined by a first yoke, with each bifurcation having a predetermined length along which a plurality of similarly configured teeth protrude in general linear alignment and correspondingly engage the actuation gear teeth when the pull lever body is lifted. The lower rack portion similarly includes a pair of tines joined by a second yoke, with each tine having a predetermined length along which a plurality of similarly configured teeth protrude in general linear alignment and correspondingly engage the &tents when the flapper is coupled to the debris collection canister.

In some embodiments of a debris collection device, a locking appliance is provided on at least one of the pull lever body and the rack. Such a locking appliance is configured to prevent inadvertent release of accumulated debris.

The controlled tension apparatus may further include a pulley system operable with a wire having an extent rotatably supported adjacent the pull lever body and an opposed extent secured to a finial disposed in the flapper latch. The flapper latch can incorporate at least one of an internal wall against which a finial head is seated when the flapper is in the stationary state, and a protruding lock tab opposite the internal wall of the flapper latch. The lock tab includes an overhang that extends over a ridge in the debris collection canister when the flapper is in the stationary state, with the lock tab and the ridge having a predetermined slack distance therebetween.

A biasing spring can be positioned intermediate the internal wall and the lock tab of the flapper latch. The spring has opposed engagement extents for releasably securing the spring to the flapper latch and the flapper so that the spring urges the flapper into the stationary state.

A restrictor can be positioned intermediate the cyclonic separation system and an interior surface wall of the debris collection canister and configured to inhibit backflow of debris from the coarse debris collection area.

A method of using a debris collection device as presently disclosed is provided. The method includes at least one of lifting the pull lever body and lowering the pull lever body to control the angular range of movement of the flapper among the stationary state, the articulating state and the release state. The method may additionally include at least one of grasping the handle of the debris collection device and removing the debris collection device from the main body; transporting the debris collection device to a disposal receptacle and positioning the collective debris release outlet for receipt of accumulated debris by the receptacle; lifting the pull lever body to change the flapper from the stationary state to the articulating state until the flapper reaches the release state, with the debris collected in the coarse debris collection area and the fine debris collection area being released through the collective debris release outlet; lowering the pull lever body to change the flapper from the release state to the articulating state before returning to the stationary state; and returning the flapper to the stationary state. While the flapper is in the articulation state, controlled tension realized by the flapper effects commensurate control of a flow rate of debris through the collective debris release outlet.

A bagless surface cleaning apparatus is provided that includes a base suction unit, an apparatus handle and a main body provided intermediate the base suction unit and the apparatus Handle. The main body has a chamber within which a debris collection device is operably supported. The debris collection device includes a debris collection canister that accommodates a centrifugal separation system and, together with the centrifugal separation system, defines a course debris collection area and a fine debris collection area within which debris accumulates. A debris collection cover is coupled with the debris collection canister, and a handle is formed on at least one of the debris collection canister and the debris collection cover. The handle is configured to be grasped by a user for removal of the debris collection device from, and replacement of the debris collection device in, the main body. The handle is also configured for carrying the debris collection device upon removal from the main body. An actuatable flapper is provided at or adjacent a collective debris release outlet from which accumulated debris is released from the course debris collection area and the fine debris collection area. A controlled tension apparatus controls an angular range of movement of the flapper for controllable release of accumulated debris from the collective debris release outlet.

A controlled tension apparatus is provided that controls release of debris from a debris collection device. The controlled tension apparatus actuates a flapper among (1) a stationary state in which the flapper obstructs release of debris from a coarse debris collection area and a fine debris collection area provided in the debris collection device; (2) an articulating state in which the flapper traverses a controlled angular range of motion so as to at least partially release debris from at least one of the coarse debris collection area and the fine debris collection area; and (3) a release state in which the flapper permits full release of accumulated debris from the coarse debris collection area and the fine debris collection area. The controlled tension apparatus can include a rack and pinion assembly that operably joins the flapper to a manually liftable pull lever such that manipulation of the pull lever effects corresponding actuation of the flapper relative to a collective debris release outlet through which accumulated debris departs the coarse debris collection area and the fine debris collection area. Such a controlled tension apparatus may be provided in combination with at least one of a debris collection device and a bagless surface cleaning apparatus.

Additional aspects of the presently disclosed methods, devices and systems will be made apparent from the following detailed description.

### BRIEF DESCRIPTION OF THE DRAWINGS

The nature and various advantages of the present invention will become more apparent upon consideration of the following detailed description, taken in conjunction with the accompanying drawings, in which like reference characters refer to like parts throughout, and in which:

FIGS. 1 and 1A show respective front and rear perspective views of an exemplary embodiment of a bagless surface cleaning apparatus.

FIGS. 2 and 2A show respective front perspective and rear perspective views of an exemplary embodiment of a main body of the surface cleaning apparatus of FIGS. 1 and 1A with an exemplary debris collection device operatively supported thereby.

FIG. 3 shows a front perspective view of the exemplary main body of FIGS. 2 and 2A with the debris collection device removed therefrom.

FIG. 4 shows a rear perspective view of the debris collection device of FIGS. 2 and 2A apart from the main body.

FIG. 4A shows a bottom perspective view of the debris collection device of FIG. 4.

FIG. 5 shows an exploded view of the exemplary debris collection device of FIG. 4.

FIGS. 6 and 6A show respective cross-sectional and edge line views of the debris collection device of FIG. 4 along line A-A.

FIG. 6B shows an exemplary flapper used with the debris collection device of FIG. 4.

FIG. 6C shows a partial exploded view of the debris collection device of FIG. 4 having an exemplary controlled tension apparatus incorporated therewith.

FIG. 6D shows a partial exploded view of the flapper of FIG. 6B and the controlled tension apparatus of FIG. 6C incorporating a lower rack and pinion assembly.

FIG. 6E shows a partial sectional view of the flapper of FIG. 6B with the flapper in a stationary state so as to obstruct a collective debris release outlet of the debris collection device.

FIG. 6F shows a partial exploded view of the controlled tension apparatus of FIG. 6C incorporating an upper rack and pinion assembly.

FIG. 6G shows a partial exploded view of a pull lever portion of the upper rack and pinion assembly of FIG. 6F.

FIG. 7 shows a side perspective view of an exemplary debris collection device as shown and described herein with the flapper in an articulating state so as to at least partially release collected debris from the collective debris release outlet of the debris collection device.

FIG. 8 shows a side perspective view of the debris collection device of FIG. 7 with the flapper in a release state so as to release collected debris from the collective debris release outlet of the debris collection device.

FIGS. 9 to 13A show alternative exemplary debris collection devices that employ controlled tension apparatuses to control the release of collected particulates and debris.

### DETAILED DESCRIPTION

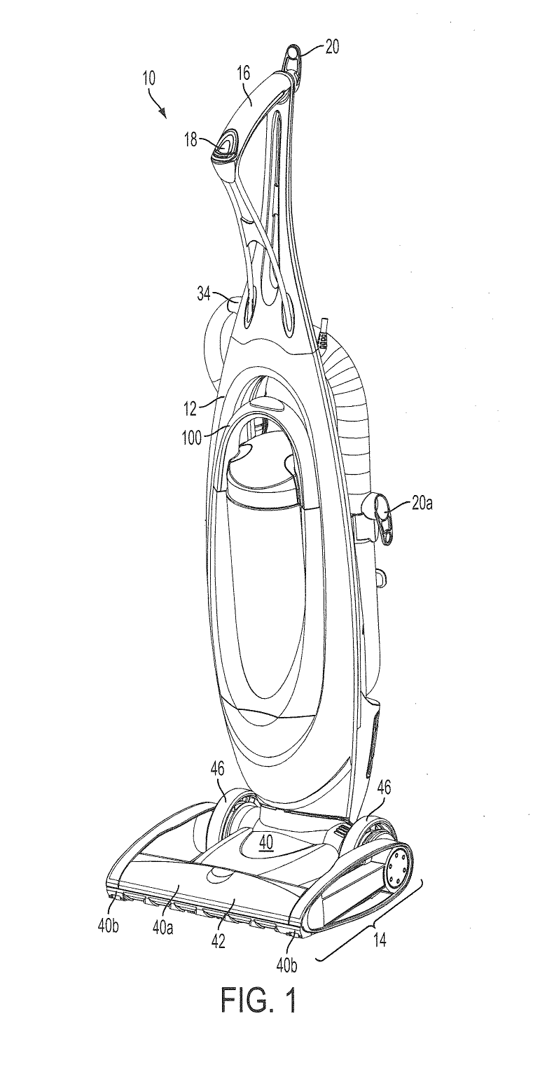

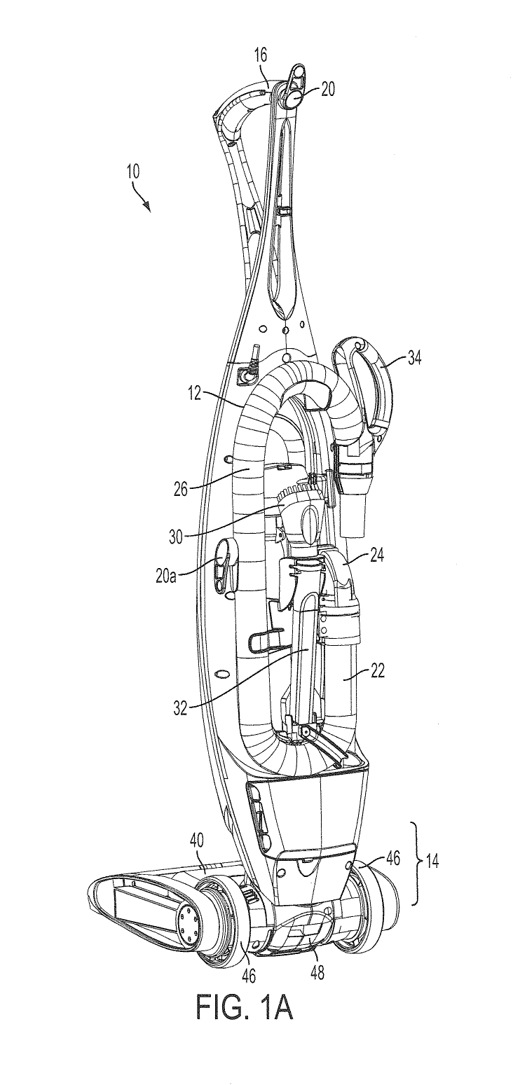

Now referring to the figures, wherein like numbers represent like elements, FIGS. 1 and 1A show an exemplary bagless surface cleaning apparatus 10 having a main body 12, a base suction unit 14 for cleaning a surface or medium and an apparatus handle 16 provided, on main body 12 for propelling and maneuvering main body 12 and base suction unit 14 thereby.

Main body 12 includes apparatus handle 16 that facilitates grasping and maneuvering of cleaning apparatus 10 by a user. Handle 16 may include at least a power button 18 integral therewith and in operational communication with a power source that actuates a vacuum motor (not shown). Such a power source, for example, may be electricity provided through a power cord 19 (shown in partial view in FIGS. 1 and 1A) in electrical communication with cleaning apparatus 10. When a user depresses power button 18, cleaner apparatus 10 is correspondingly activated or deactivated (or alternatively subject to a change in cleaning function selection) during a cleaning operation. One or more other actuators may be incorporated with handle 16 to execute one or more additional functions, including but not limited to buttons, dials or touch displays for optional speed settings and cleaning surface settings (e.g., wood and laminate floor settings, low-, medium- and high-pile carpet settings, upholstery and drapery settings, etc.).

As used herein, “cleaning surface”, “surface” and “cleaning medium” are used interchangeably to include any area, region, substrate, surface and other medium that can be acted upon by cleaning apparatus 10. Examples of “cleaning surfaces” and “cleaning media” include, but are not limited to, carpets, floors (including floors fabricated from hardwood, linoleum, ceramic, marble and other complementary and equivalent materials), mattresses (including mattresses for humans and pets), furniture (including fully or partially upholstered furniture, wooden furniture, metal furniture, patio and sunroom furniture and the like), accessories (including textile accessories such as pillows, throw pillows and seat cushions), drapery, walls and ceilings (including walls and ceiling made from drywall, having textured and/or painted surfaces, incorporating wainscoting and having a covering secured thereon), stuffed animals, textiles and other surfaces and media. The term “carpet” as used herein includes all textile floor coverings, including but not limited to those having fibers (e.g., whether looped, tufted, hooked, needlefelt, woven or of other design), indoor or outdoor, of natural or synthetic materials, wall-to-wall textiles or roll goods.

One or more visual, tactile, audio and other indices may be provided with power button 18 (and/or any other actuator provided on handle 16) not only to help a user identify the power source activation means for cleaning apparatus 10, but also to indicate a current state of cleaning apparatus 10 (e.g., “on” or “off”). Such indices may include visual indices, such as one or more LED lights or other illumination means provided proximate power button 18. Other visual indices may include one or more letters, numbers, symbols and combinations that readily identify power button 18. Still other indices may include raised protrusions (or indentations) providing tactile guidance of the activation source for cleaning apparatus 10.

In some embodiments, handle 16 may include at least one cord retention member 20 that enables retention of power cord 19 thereby. Cord retention member 20 may be provided as a hook member as shown in the figures or alternatively provided as a retractable element extendable relative to handle 16. At least one supplementary cord retention member 20a may be incorporated anywhere along main body 12, and the disposition of such supplementary cord retention members is not limited to that illustrated herein (for example, a supplementary cord retention member may be disposed at or near a motor shroud 29 instead of, or in addition to, supplementary cord retention member 20a shown in FIGS. 1 and 1A). Overall, the various electrical components of cleaning apparatus 10 (including the motor thereof) can be powered by power cord 19, which is configured for receipt by a complementary electrical outlet or other suitable external power source. In addition to, or in place of external power sources, cleaning apparatus 10 may also be powered through the use of various battery pack systems as is known in the art, including but not limited to hybrid rechargeable power systems.

A hose connector 22 may be formed on at least a portion of main body 1 that communicates with a suction port 24 and facilitates removable fastening of an extendable hose 26. Main body 12 may have a hose carrier 28 provided thereon that permits storage of hose 26 when either the hose or the cleaning apparatus is not in use. At least one of hose connector 22 and hose carrier 28 may be integral with at least a portion of main body 12 or detachably mounted thereto by one or more fastening means as known in the art. Optional accessories for hose 26 may also be removably fastened to corresponding structure on main body 12, including but not limited to, a brush 30, a crevice tool 32 and a hose wand 34 that permits a user to guide the hose for removal of particulates from a variety of cleaning surfaces. Additional tools may include one or more brushes, squeegees, beater bars, nozzles, etc. it is understood that the incorporation of accessories and tools as shown and described herein is purely optional and does not limit the scope of the presently disclosed invention.

Main body 12 is at least supportable by abuse suction unit 14 that may include fascia 40 having a leading edge 40a and one or more side edges 40b. One or more of fascia 40, leading edge 40a and side edges 40b may have one or more designs, colors, textures and/or embellishments incorporated therewith to enhance the aesthetic features of main body 12. Alternatively, one or more of fascia 40, leading edge 40a and side edges 40b may be fabricated from one or more materials having an antimicrobial additive for treatment of infestation agents during a cleaning operation. Such materials may alternatively, or also, incorporate additives that impart easy-clean characteristics to base suction unit 14.

Leading edge 40a may include a bumper 42 thereon (or integral therewith) to protect cleaning apparatus 10 and floor and wall surfaces from inadvertent marks and impacts. One or more of fascia 40, leading edge 40a, side edges 40b and bumper 42 may include optional indicia for indicating a steering direction of base suction unit 14. For example, one or more illumination means (such as LED or fiber optic lights, not shown) may be used to illuminate at least a portion of base suction unit 14 and thereby direct a path along which cleaning apparatus 10 may be guided. Illumination means may also be used to indicate a state of cleaning apparatus 10 (e.g., “on” or “off”, “carpet mode”, “floor mode”, “need to empty debris collection cup”, etc.).

Base suction unit 14 may support an agitation member such as a beater bar (not shown) for lifting debris from a surface being cleaned. Such a beater bar may be selected from numerous beater bar embodiments, including but not limited to those beater bar embodiments disclosed by co-owned U.S. Ser. No. 10/646,233, the entire disclosure of which is incorporated by reference herein. The beater bar may be positioned within base suction unit 14 and configured to rotate during a beater bar operational mode of cleaning apparatus 10. The beater bar (or equivalent agitation member) may be in operative communication with a drive motor (not shown), such as through a belt drive (not shown) to enable rotation of the beater bar. It is contemplated that an agitation member such as a beater bar can be configured to rotate with sufficient speed to effectively impact the cleaning surface on which cleaning apparatus 10 is employed. For example, one or more actuators may be incorporated with handle 16 (as described hereinabove) to control the agitation member (or associated drive motor) for effective agitation of carpet fibers in both higher knap and lower knap carpeting.

Equivalent structure to a beater bar may be suitable for lifting debris from a cleaning surface for delivery of the lifted debris through a suction port (not shown) supported by base suction unit 14. In some embodiments, additional particulate removal features may complement the beater bar or agitation member. Such features may include, but are not limited to, one or more brushes (not shown) along an undercarriage of fascia 40. Such features may also include corrugations (not shown) provided along at least a portion of bumper 42 for disrupting particulates from a cleaning surface and eventual collection of the disrupted particulates in cleaning apparatus 10 (as further described hereinbelow).

In an embodiment where cleaning apparatus 10 is a steerable vacuum cleaner, a coupling may be provided between main body 12 and base suction unit 14. Wheels 46 can be disposed on (or in steerable communication with) the coupling to facilitate linear and non-linear travel paths that cleaning apparatus may traverse during use. In some embodiments, the coupling may comprise a yoke having wheels disposed thereon(an example of which is disclosed by co-owned U.S. Ser. No. 12/771,865, the entire disclosure of which is incorporated by reference herein). In some embodiments, the coupling may comprise a swivel joint (shown generally as swivel coupling 48 in FIG. 1A) at the junction of the base suction unit and the main body. In such embodiments, the swivel joint causes base suction unit 14 to turn right with a clockwise twist of the handle and turn left with a counter-clockwise twist of the handle. Cleaning apparatus 10 may therefore exhibit optional maneuverability such that base suction unit 14 is responsive to the user and achieves a turning effect, rather than a sliding effect, during use. In such a configuration, a user need only maneuver apparatus handle 16 to propel base suction unit 14 relative to the cleaning surface and thereby direct cleaning apparatus 10 as desired to optimize particulate suction over a cleaning surface.

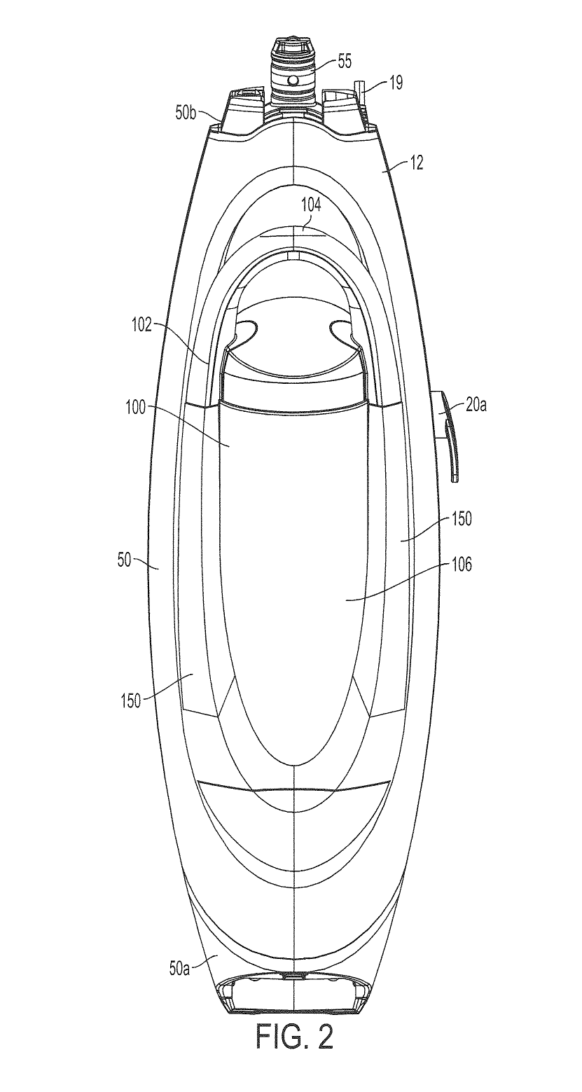

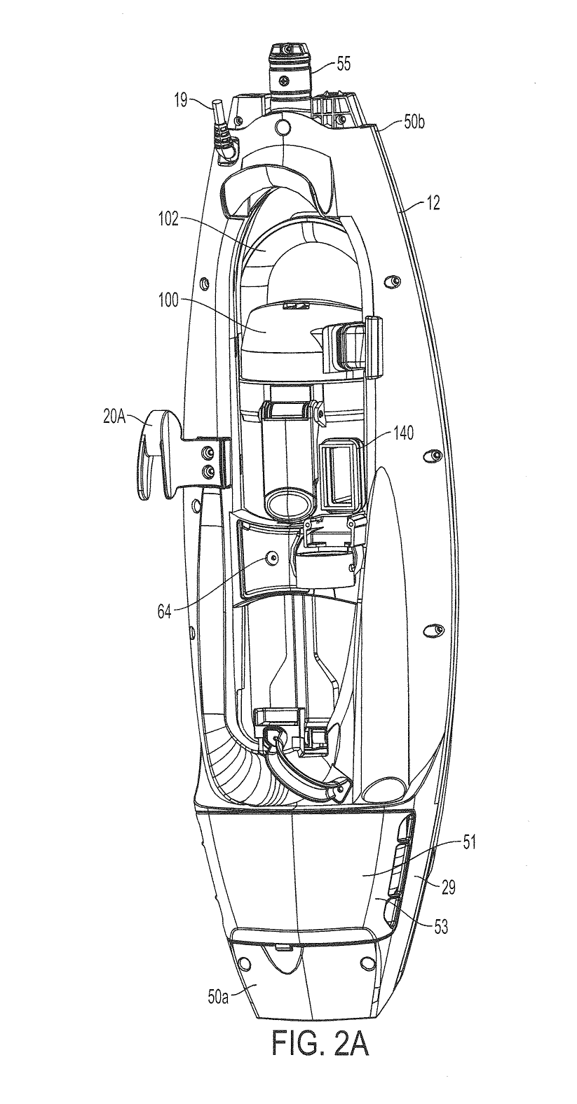

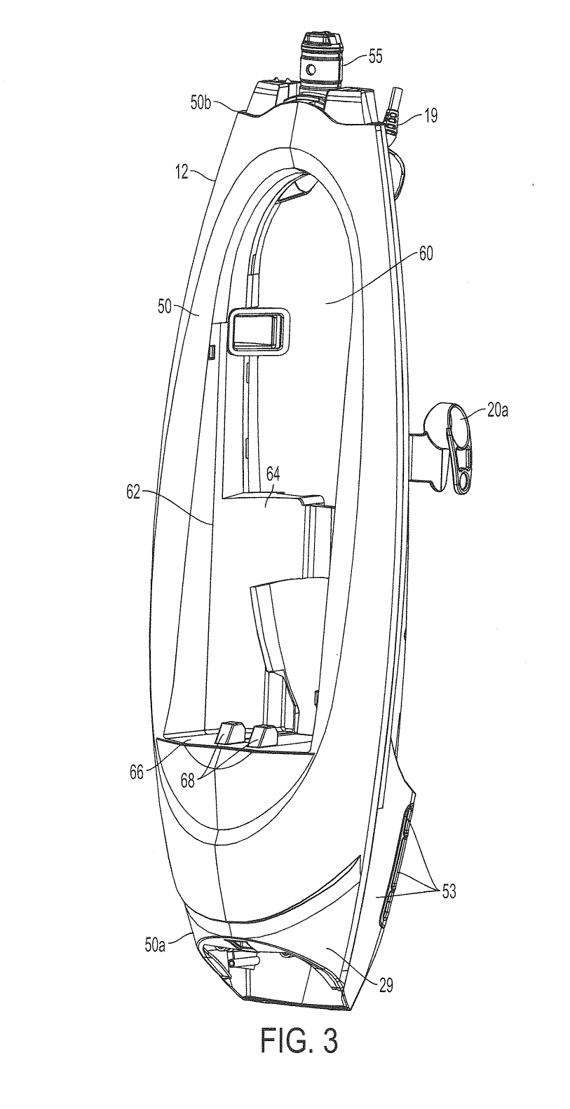

Referring further to FIGS. 2, 2A and 3, main body 12 is shown apart from cleaning apparatus 10 together with an exemplary debris collection device 100 supported thereby. Main body 12 incorporates a carapace 50 having a base extent 50a proximate base suction unit 14 (shown in FIGS. 1 and 1A). Base extent 50a may include structure for communicating engagement with base structure 14 as known in the art. Base extent 50a may include further housing structure for housing vacuum motor features therein as shown generally by motor shroud 29. Motor shroud 29 may optionally incorporate a filter access door 51 that permits access to an exhaust filter (not shown), which exhaust filter may be a HEPA filter or any comparable or equivalent filtering means. One or more vents 53 may be incorporated in at least a portion of base extent 50a to facilitate airflow egress from cleaning apparatus 10.

Carapace 50 also includes a handle extent 50b proximate handle member 16 (as shown in FIGS. 1 and 1A). Handle extent 50b may include structure for engagement with handle member 16 as shown herein. For example, as shown in FIGS. 2, 2A and 3, such structure may include a ferrule 55 that facilitates removable securement of handle member 16 with main body 12, for instance by snap-tight engagement, snap-click engagement, thread-fit engagement and any complementary and equivalent engagement means amenable to practice of the presently disclosed cleaning apparatus. It is understood that ferrule 55 represents exemplary engagement structure and that structure for removable securement of handle member 16 with main body 12 may incorporate one or more complementary and equivalent fastening systems, either known or hereafter derived.

Main body 12 additionally includes a chamber 60 (see FIG. 3) within which a debris collection device 100 is removably secured to the main body during use or storage of cleaning apparatus 10. Chamber 60 may include a wall 62 that delineates a receiving area having a contour complementary to that of debris collection device 100. An optional anchor 64 may provide additional support for debris collection device 100 as well as a support for one or more selective mountings (e.g., a crevice tool mounting for crevice tool 32 shown in FIG. 1A).

Chamber 60 further includes a seat 66 that supports debris collection device 100 thereupon. Seat 66 may include optional engagement means for removable retention of debris collection device 100. Such engagement means may include one or more protruding engagement teeth 68 that releasably retain corresponding structure in debris collection device 100 in snap-tight engagement (as further described hereinbelow). In this manner, chamber 60 envelops debris collection device 100 so as to provide a cooperating profile between the debris collection device and main body 12.

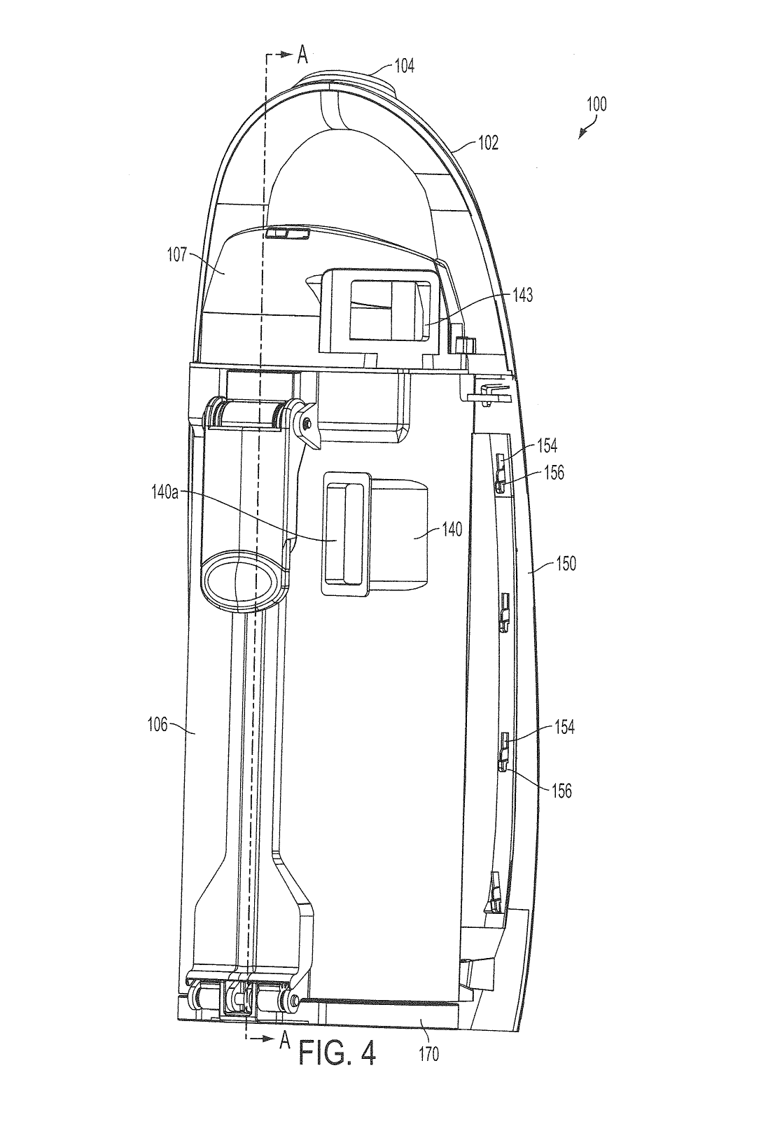

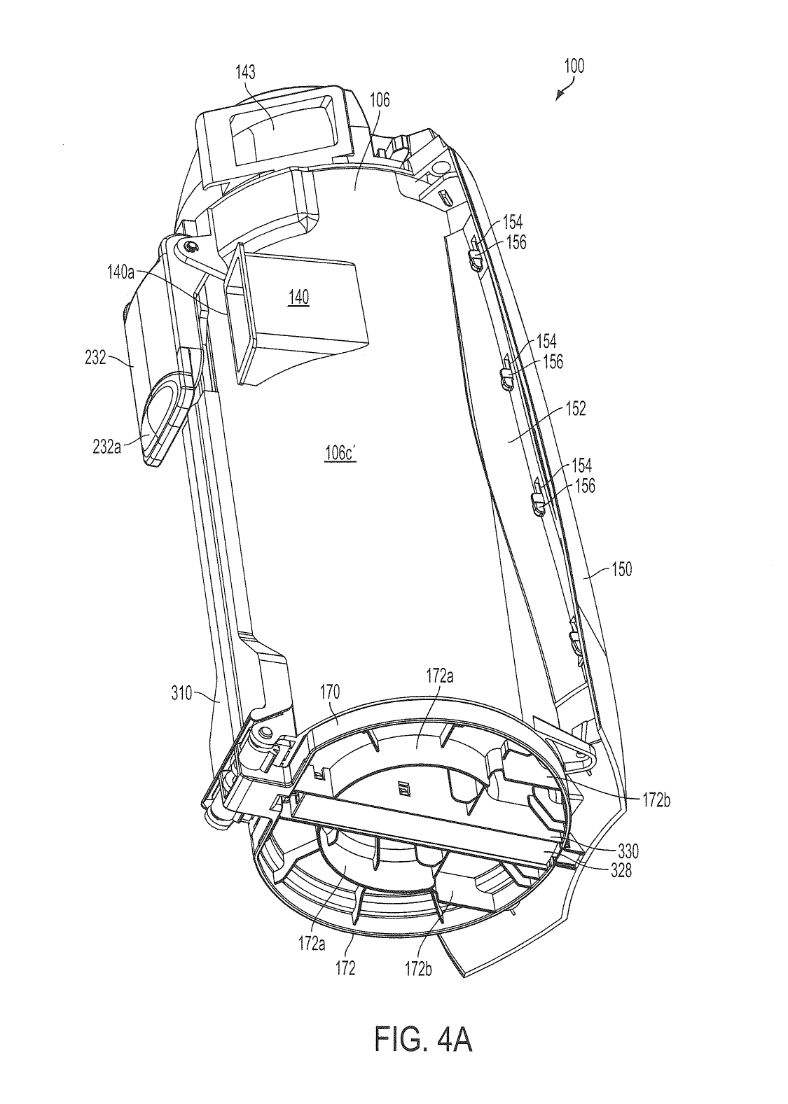

Referring further to FIGS. 4 and 4A, debris collection device 100 includes a device handle 102 that is readily grasped by a user for removal of the debris collection device from, and insertion of the debris collection device into, chamber 60. Handle 102 may be an integral component or an assembly of interchangeable components that may be formed on or coupled with at least one of a debris collection canister 106 and a debris collection cover 107. In an embodiment where handle 102 is incorporated with cover 107, a user may grasp handle 102 to effect separation and coupling of the debris collection cover relative to canister 106 (e,g., via frictional fit, complementary threaded engagement and the like). Although debris collection device handle 102 is shown as a generally arcuate member, it is understood that such handle may assume any geometry amenable to practice of the presently disclosed invention.

A user may grasp handle 102 to remove debris collection device 100 from chamber 60 and carry the debris collection device and its contents to another location (e.g., for disposal of collected particulates into a disposal vessel such as a dustbin or trash receptacle). Debris collection device 100 may alternatively be carried and inserted into a chamber of another cleaning apparatus that operatively receives debris collection device 100 thereby. In exemplary embodiments where debris collection device 100 is in snap-tight engagement with engagement teeth 68, a user may remove debris collection device 100 from chamber 60 simply by grasping debris collection device handle 102 and applying a pulling force sufficient to overcome the retention force between engagement teeth 66 and debris collection device 100 (as further described, hereinbelow). Instead of or in addition to, engagement teeth that releasably secure debris collection device 100 in chamber 60, handle 102 may include one or more retractable pins (not shown) that cooperate with corresponding recesses (not shown) in chamber wall 62. Such pins retract from their corresponding recesses upon depression of one or more optional actuators, such as an optional actuator button 104 provided on handle 102.

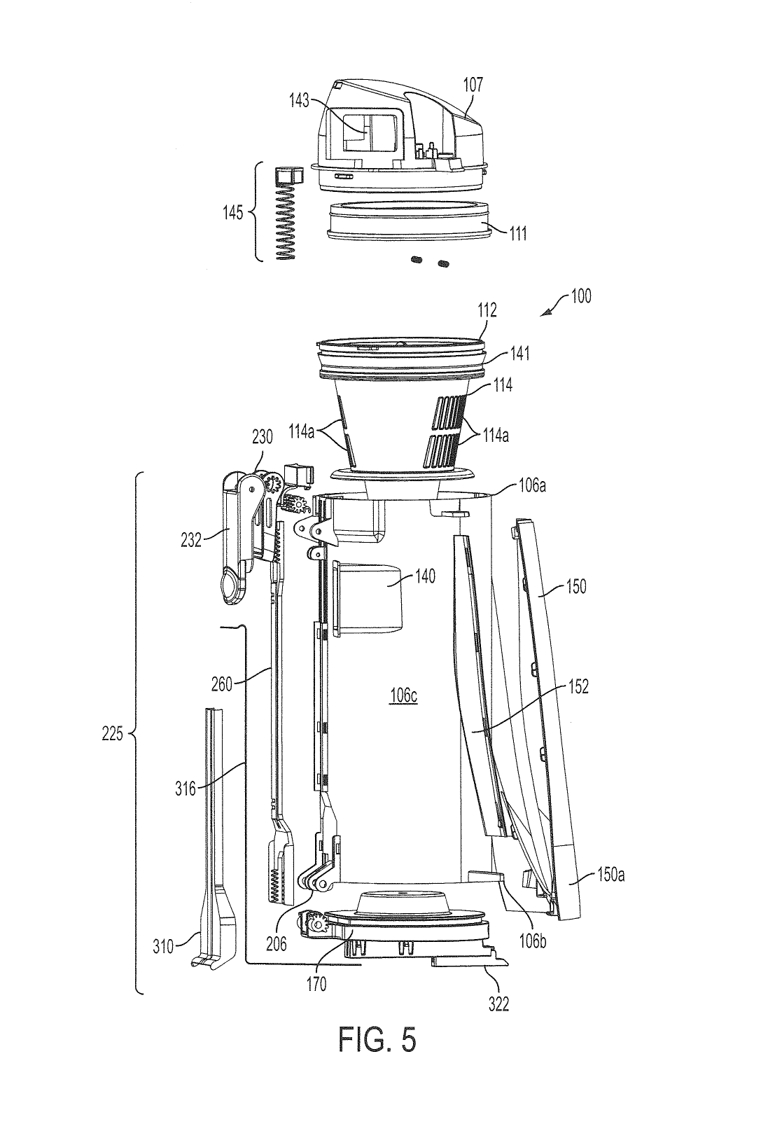

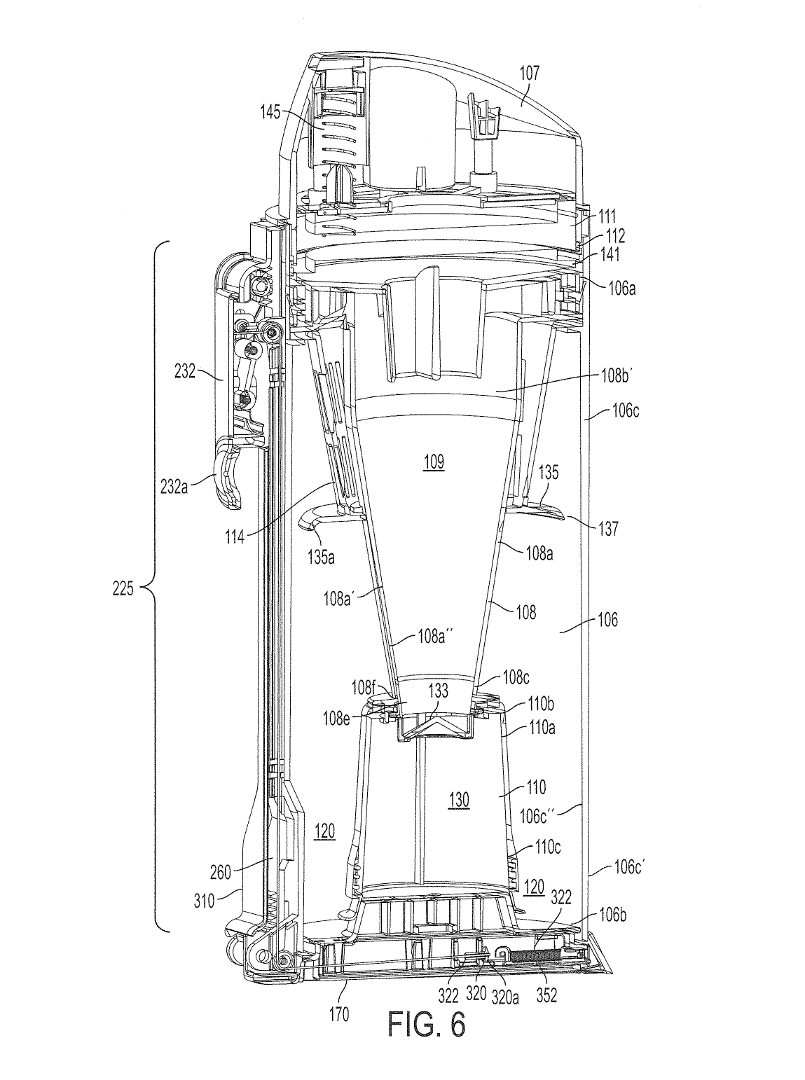

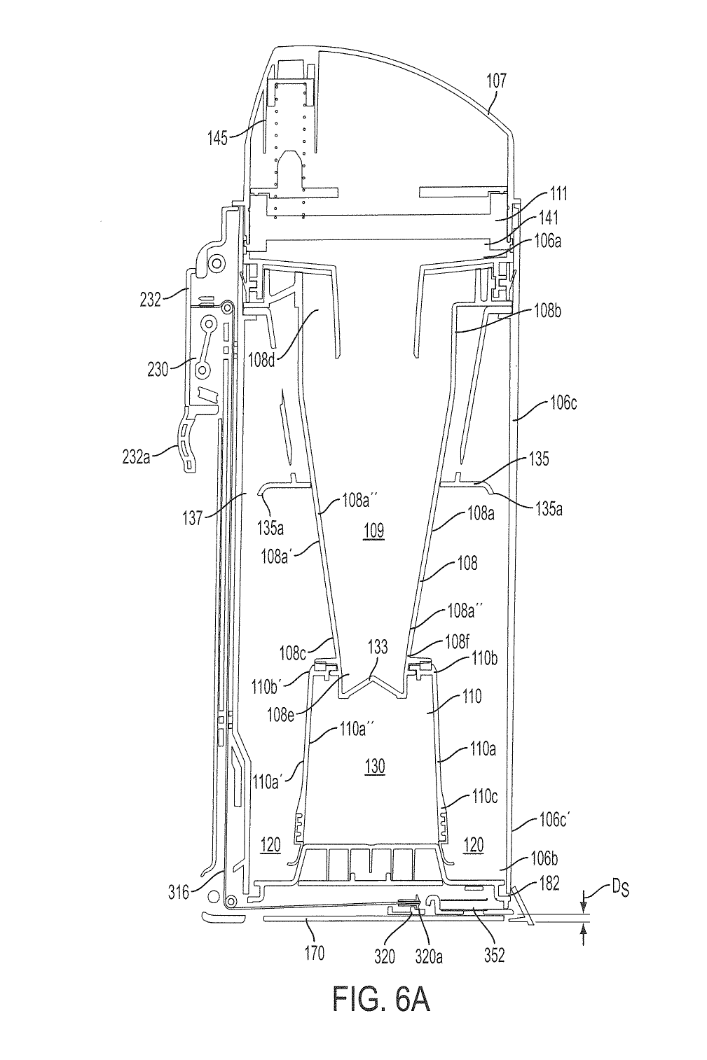

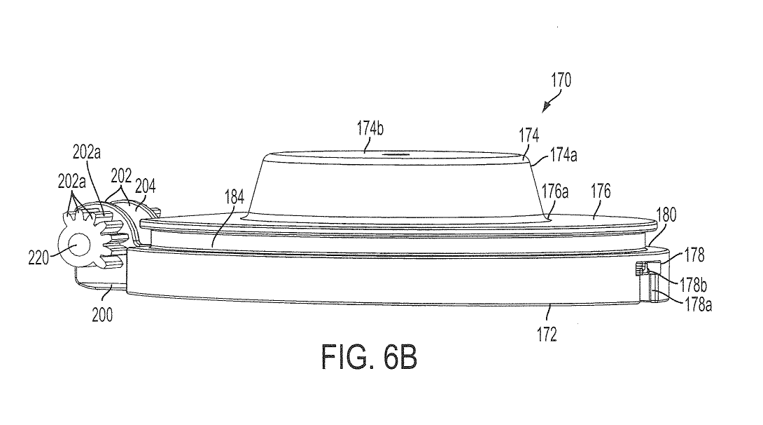

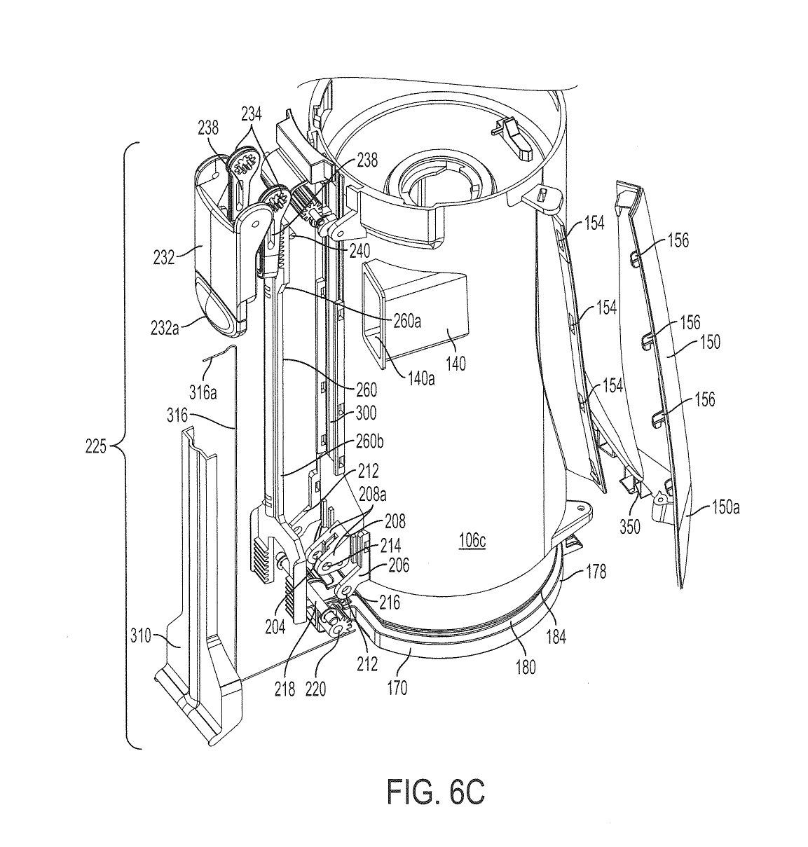

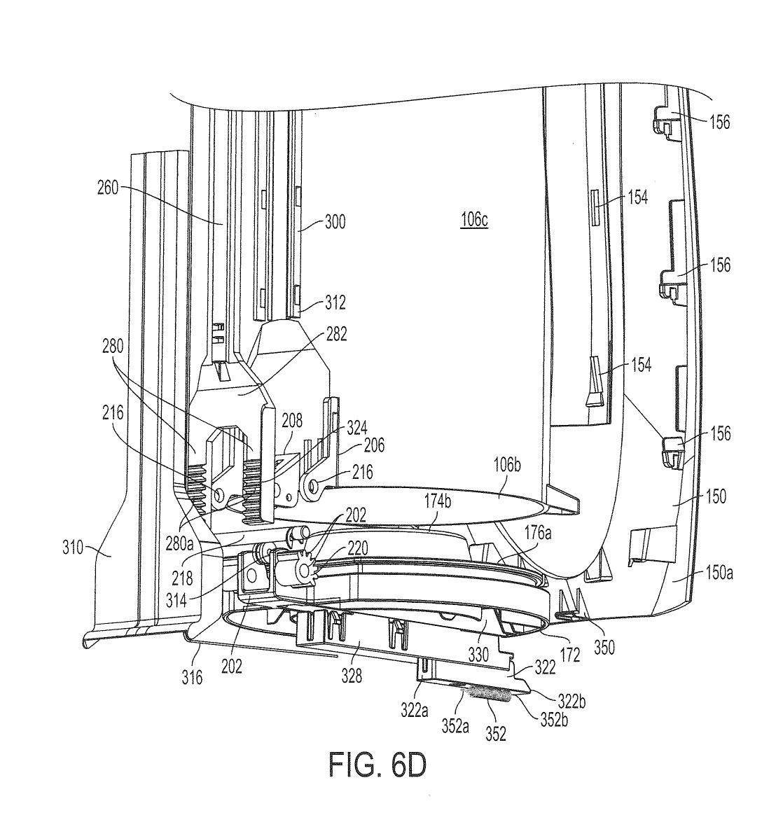

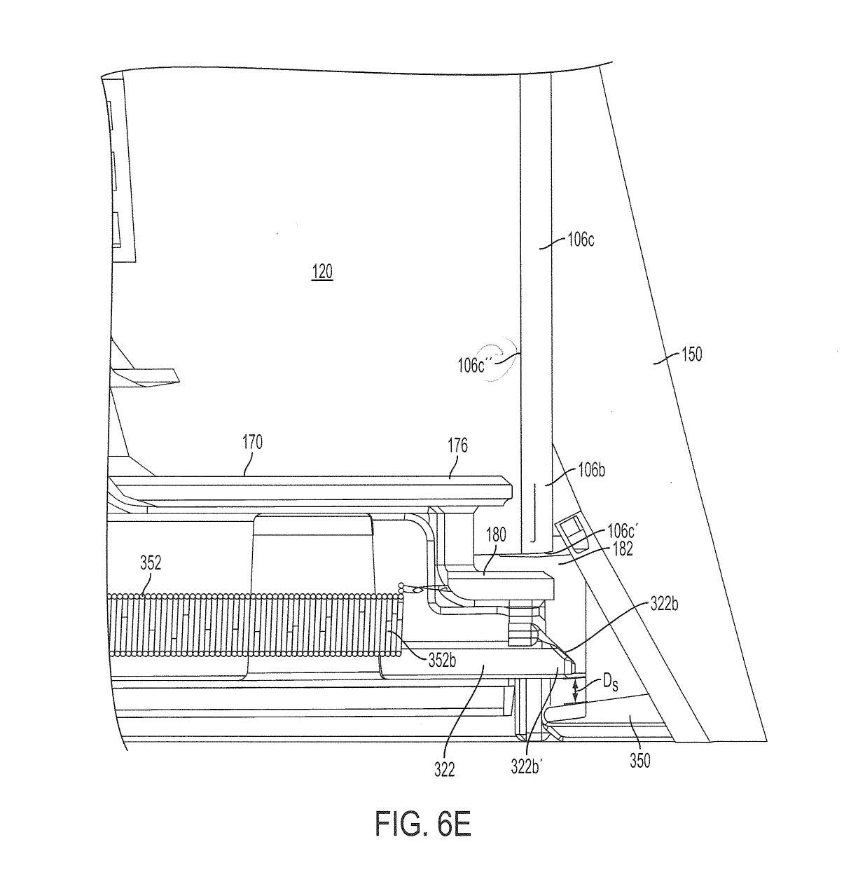

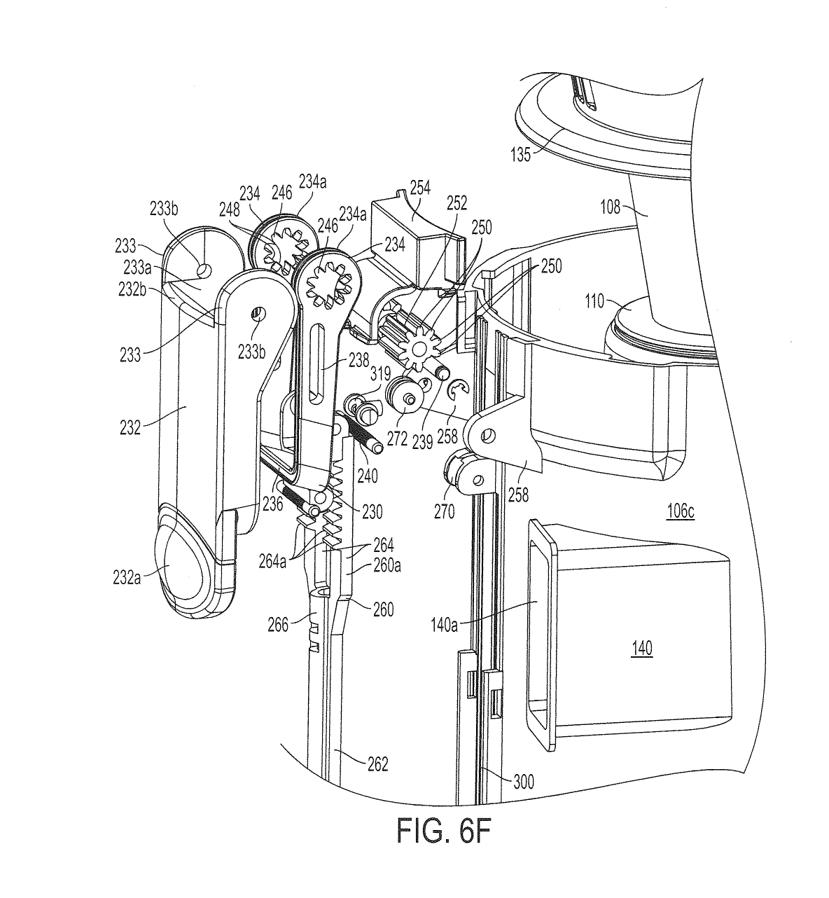

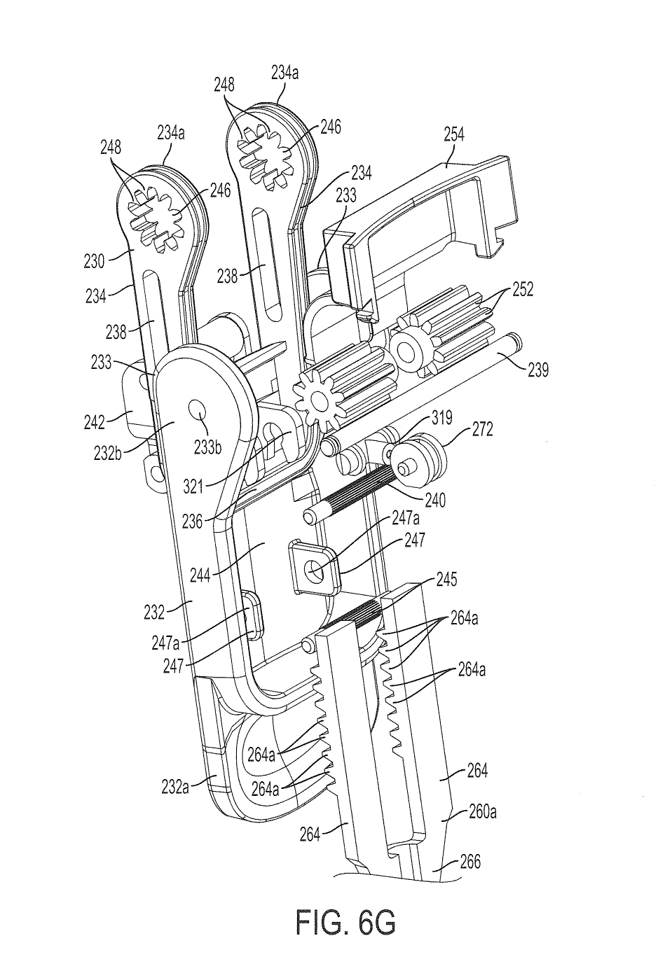

Further referring to FIGS. 5, 6 and 6A, debris collection device 100 includes a canister 106 having a top extent opening 106a, a bottom extent opening 106b and a coextensive side wall 106c. Side wall 106c includes an outer surface 106c′ and an inner surface 106c″ with a predetermined thickness delineated therebetween. Inner canister surface 106c″ defines a recess within Which a centrifugal separation structure is housed. Although an exemplary centrifugal separation structure is shown and described herein, it is contemplated that a plurality of exemplary centrifugal separation systems are amenable for use with the presently disclosed cleaning apparatus. Such systems typically include one or more cyclonic separators for centrifugal separation of particulates from airflow. Included in such exemplary systems are those exemplary embodiments presently disclosed by Applicants' co-owned and co-pending U.S. Ser. No. ______ entitled DUAL-STAGE CYCLONIC AIR SEPARATOR, the entire disclosure of which is incorporated by reference herein.

Referring further to FIGS. 6 and 6A, an exemplary cyclonic separator housed by canister 106 includes a cyclonic frustum 108 and a debris collection cup 110. Cyclonic frustum 108 incorporates a generally arcuate wall 108a having outer wall surface 108a′ that directs a primary centrifugal airflow and inner wall surface 108a″ that delineates a region 109 for a secondary centrifugal airflow. Frustum walls 108a taper generally inwardly from a proximate frustum extent 108b disposed adjacent top extent opening 106a toward a distal frustum extent 108c. As shown herein, cyclonic frustum 108 may incorporate a cyclone tube 108b′ that terminates in an opening 108d at which additional centrifugal separation structure may be disposed. Such additional structure may include a filter 111 supported by a filter support 112 and a cyclone sieve 114 provided in the vicinity of proximate frustum extent 108b. Cyclone sieve 114 may include a plurality of rounded-edge apertures 114a that re-direct airflow inside canister 106. One or more keels (not shown) incorporated in proximity of proximate frustum extent 108b may be provided that speed up and deliver the re-directed airflow to the secondary centrifugal airflow region delineated by inner wall surface 108a″.

Debris collection cup 110 incorporates a generally arcuate wall 110a coextensive with an open proximate cup extent 110b and an opposed open distal cup extent 110c. Cup wall 110a includes an exterior surface 110a′ that, together with interior canister surface 106c″ and exterior frustum surface 108a′, define a coarse debris collection area 120 within which particulates and debris retrieved by cleaning apparatus 10 are deposited by the primary centrifugal airflow. Debris collection cup 110a also includes an interior surface 110a″ that delineates a fine debris collection area 130 Debris may be deposited into fine debris collection area 130 from an opposed frustum opening 108e provided at distal frustum extent 108c. Proximate cup extent 110b has a seat 110b′ for supporting a seating flange 108f circumferentially depending from outer frustum wall surface 108a′ near opposed frustum opening 108e.

A portion of frustum wall 108a depends inwardly into fine debris collection area 130 such that opposed frustum opening 108e is enclosed by and positioned within the fine debris collection area. An optional sifter 133 may be disposed a predetermined distance from opposed frustum opening 108e so as to direct debris deposits from region 109 into fine debris collection area 130. Sifter 133 is depicted as a generally frustoconical element having an axis generally coincident with the longitudinal axes of cyclone frustum 108 and debris collection cup 110. It is contemplated that sifter 133 may incorporate various other geometries that facilitate deposit of captured particulates to fine debris collection area 130.

Other additional centrifugal separation structure may include a debris restriction flange 135 that may be integral with frustum wall 108a or cyclone sieve 114. Debris restriction flange 135 can incorporate a concave lip 135a along a flange periphery that deflects debris back into course debris collection area 120. A predetermined clearance 137 between lip 135a and inner wall surface 108a″ inhibits delivery of coarse particulates from coarse debris collection area 120 while permitting unimpeded airflow to region 109.

At least one air ingress 140 may be provided that depends generally normally relative to canister wall surface 106c′ and defines a lumen 140a therethrough. Lumen 140a may facilitate communication of dirty air from a conduit (such as hose 26 shown in FIG. 1A) to debris collection device 100 (and more particularly to coarse debris collection area 120). Air ingress 140 may communicate with hose 26 that is in fluid communication with a suction port (not shown) as generally known for delivering suction to a cleaning surface. Particulate-laden air is delivered through air ingress 140 such that the particulates tangentially impinge aside wall of cyclone frustum 108. The particulate-laden air is thereby subject to centrifugal separation, such that the particles separate from the air for collection in coarse debris collection area 120.

A periphery for each of course debris collection area 120 and fine debris collection area 130 is further established by top and bottom surfaces that are respectively provided at or adjacent top open extent 106a and bottom open extent 106b of canister 106. Such surfaces ensure retention of multiple-sized particulates in canister 106 and consequent removal of such particulates from an environment in which cleaning apparatus 10 is used. In some embodiments, a body such as filter element 111 or gasket member 141 may provide an upper periphery of course debris collection area 120. Filter element 111 and gasket member 141 may be disposed proximate upper frustum extent 108b so as to be housed intermediate canister 106 and debris collection cup cover 107. Air that has travelled through canister 106 and has deposited debris in course debris collection area 120 and fine debris collection area 130 traverses filter element 111. The resulting clean and filtered airflow departs debris collection device 100 through an airflow egress 143 provided in cover 107, which cover may include an optional bleed valve 145 as known in the art.

Debris collection device handle 102 cooperates with a canister frame 150 that may comprise a single member or multiple members so as to be generally coextensive with an open face of main body 12 when debris collection device 100 is supported by chamber seat 66. A distal extent 150a of canister frame 140 may be cooperatively configured to be seated in chamber seat 68 so as to be coextensive with the chamber seat when debris collection device 100 is seated therein (see FIG. 2).

Canister frame 150 may be integral with outer canister surface 106c′ or, alternatively, securable to one or more wings 152 depending generally outwardly from outer canister surface 106c′ along at least a portion of the outer surface's longitudinal extent. At least one of canister frame 150 and wings 152 may include one or more notches 154 that cooperate with corresponding catches 156 on another of canister frame and the wings. Such a configuration not only ensures against inadvertent displacement of the canister frame relative to the debris collection device when the debris collection device is in use (e.g., while seated in chamber 60, during removal from or insertion into chamber 60 or during carrying of the debris collection assembly). The disclosed embodiment also facilitates a variety of aesthetic features, including but not limited to presentation of a plurality of colors, geometries, embellishments, logos and combinations thereof as sought by users and potential users.

Referring further to the figures and particularly to FIG. 6B, in a preferred embodiment, a rotatable flapper 170 disposed at or adjacent bottom open extent 106b provides a bottom periphery for each of coarse debris collection area 120 and fine debris collection area 130. Flapper 170 includes a support surface 172 (see FIGS. 4A and 6B) that is seated proximate chamber seat 66 and supported thereby when debris collection device 100 is disposed in chamber 60. Flapper support surface 172 includes at least one or more annular ribs 172a that support debris collection device 100 along with all of the debris collected in canister 106. In some embodiments, flapper support surface 172 may also have complementary ribs 172b depending therefrom that engage with corresponding engagement structure provided in chamber seat 66 (including but not limited to engagement teeth 68 described hereinabove). Alternatively, flapper support surface 172 may be frictionally fit relative to chamber seat 66 when debris collection device is disposed in chamber 60. Canister frame 150 may cooperate with one or more of annular ribs 172a and complementary ribs to align canister 106 within chamber 60 and guide the canister until secured within seat 66.

Flapper 170 further includes a pedestal 174 having a generally cylindrical side wall 174a depending upwardly from a generally planar floor 176. Floor 176 includes a collection surface 176a that supports coarse debris as it accumulates in coarse debris collection area 120. Pedestal 174 terminates in an upper wall extent 174b that cooperates with open distal cup extent 110c to support fine debris as it accumulates in fine debris collection area 130. Upper wall extent 174b therefore serves as a barrier to the egress of fine particulates from fine debris collection area 130 when flapper 170 is the flapper in a stationary state. In the stationary state, flapper 170 obstructs bottom extent opening 106b that serves as a collective debris release outlet of the debris collection device (e.g., as shown in FIG. 5). A sealing means such as a sleeve gasket (not shown) may be provided at or Bear open distal cup extent 110c to ensure retention of fine particulates within debris collection cup 10 until disposal thereof through bottom extent opening 106b.

Flapper 170 further includes a generally annular side wall 178 coextensive with flapper support surface 172 and a flapper seat 180. Flapper seat 180, together with bottom open extent 106b of canister 106, provides an interface 182 between flapper 170 and canister 106 when the flapper is in a closed position. Interface 182 defines a predetermined clearance between flapper seat 180 and a seating surface 106c′ of bottom open extent 106b that ensures ready release of flapper 170 as further described herein (see FIG. 6E). A generally annular groove 184 that is provided intermediate floor 176 and flapper seat 180 facilitates insertion and operation of a similarly configured seal member (not shown). The seal member, which may be selected from a plurality of configurations comprising a compressible material, prevents airflow and particulate departure through interface 182. A sufficient sealing means is thereby provided to obviate inadvertent release of debris from fine debris collection area 130.

Flapper 170 is rotatably coupled with canister side wall 106c (and thereby actuatable relative to bottom open extent 106b of canister 106) via a pinion joint 200 depending from flapper side wall 178 opposite interface 182. Pinion joint 200 includes a pair of pinions 202 each having a plurality of similarly sized and shaped detents 202a. Pinions 202 are generally symmetrically disposed on either side of a pinion joint cavity 204. Flapper side wall 178 incorporates an aperture 178a diametrically opposed to pinion joint 200 that is generally dimensioned, for sliding receipt of a bottom latch 322 as further described herein.

As seen in FIGS. 6C and 6D, pinion cavity 204 accommodates pinion scaffold 206 depending from outer canister surface 106c′ adjacent bottom open extent 106b of canister 106. Pinion scaffold 206 includes a scaffold clutch 208 having fingers 208a with each clutch finger having an outer surface and an inner surface spaced by a predetermined distance therebetween to accommodate uninterrupted movement of a pulley cable or wire 316 (the operation of which is farther described hereinbelow). Each clutch outer surface is spaced a predetermined distance from an inner surface of a scaffold bracket 212 depending from canister outer surface 106c′. Each clutch finger 208a and each bracket 212 includes a respective aperture 214, 216 that accommodates insertion of a rotatable axle 218 therethrough. Each pinion 202 also includes an aperture 220 therethrough that accommodates insertion of a flapper axle 218 when pinion apertures 220 are in general alignment with apertures 214,216.

A controlled tension apparatus contemplated for use with debris collection device 100 includes a rack and pinion assembly 225 that operably joins flapper 170 to a manually liftable pull lever 230 (see FIGS. 6C, 6F and 6G) such that manipulation of the pull lever effects corresponding actuation of flapper 170 relative to canister 106. Rack and pinion assembly 225 includes pull lever 230 housed by a pull lever body 232 having a gripping extent 232a that can be readily grasped by a user and an opposed mounting extent 232b. A pair of mounting arms 233 depend outwardly from a mounting shoulder 233a, each of which incorporates an aperture 233a thereat for rotatable insertion of an axle 239 therethrough. Mounting shoulder 233a may serve as a stop that defines an angular range of motion over which pull lever body 232 may be articulated.

In the exemplary embodiment shown, pull lever 230 includes a pair of actuation arms 234 extending from a shoulder 236 and terminating in free extents 234a. Each actuation arm 234 includes a longitudinal aperture 238 along which a pull lever shaft 240 is guided when gripping extent 232a is rotated outwardly relative to outer canister surface 106c′. Pull lever shaft 240 is retained by a hinge bracket 242 hingedly mounted by a mounting shaft 245. Mounting shaft 245 cooperates with a pair of bracket mounts 247 having apertures 247a that accommodate rotatable insertion of shaft 245 therethrough. Bracket mounts 247 depend outwardly from an undercarriage 244 of pull lever body 232 proximate gripping extent 232a. Therefore, lifting of the pull lever body translates rotation to hinge bracket 242 and consequent slidable engagement of pull lever shaft 240 within arm apertures 238.

An actuation gear aperture 246 defined at each free arm extent 234a includes recessed teeth 248 complementing a plurality of gear teeth 250 provided on a complementary actuation gear 252 received thereby. Actuation gears 252 are housed by a gear cover body 254 and rotatable about axle 245 supported by an axle bracket 258 depending generally normally from outer canister surface 106c′ proximate top open extent 106a of canister 106.

Rack and pinion assembly 225 also includes a rack 260 having an upper portion 260a disposed proximate top open extent 106a of canister 106 and a lower portion 260b disposed proximate bottom open extent 106b of the canister. A generally elongate rack body 262 is provided intermediate upper and lower racks 260a, 260b. Upper rack portion 260a includes bifurcations 264 joined by a first yoke 266. A predetermined space provided between adjacent inner surfaces of bifurcations 264 accommodates movement of upper rack 260a relative to a pulley bracket 270 depending generally normally from outer canister surface 106c′. A top pulley 272 is operably mounted to pulley bracket 270 as further described herein. Each bifurcation 264 has a predetermined length along which a plurality of similarly configured teeth 264a protrude in general linear alignment. Upper rack teeth 264a correspondingly engage actuation gear teeth 252 when pull lever body 232 is actuated.

In some embodiments, at least one of pull lever body 232 and rack body 262 includes a locking appliance integral therewith. In an exemplary embodiment, one or more hooks (not shown) may be provided along undercarriage 244 of pull lever body 232 for locking engagement with corresponding catches (not shown) provided on rack body 262. The catches may also serve as detents that help to define the range of movement of rack 260 upon actuation of pull lever 230. Although complementary hooks and catches are described herein with respect to such locking appliances, it is understood that other locking systems may be employed without departing from the scope of the present disclosure. Such locking systems may incorporate structure that incorporates one or more of audible, visual and tactile indicia that serve as confirmation of locking engagement. Inadvertent release of flapper 170 can be prevented, thereby obviating the unintentional release of collected debris (e.g., on or near a just-cleaned surface).

As further shown in the figures with particular reference to FIG. 6C, lower rack portion 260b includes a pair of tines 280 joined by a second yoke 282 with a predetermined space defined between adjacent inner surfaces of tines 280 that accommodates movement of the lower rack relative to pinion scaffold 206. Each tine 280 has a predetermined length along which a plurality of similarly configured teeth 280a protrude in general linear alignment. Lower rack teeth 280a correspondingly engage pinion detents 204 when flapper 170 is rotatably coupled with canister 106 at pinion scaffold 206.

Also shown in FIG. 6C is a guide track 300 that may be provided in some embodiments outside at least a portion of the longitudinal extent of outer canister surface 106c′. Guide track 300 accommodates linear movement of rack 260 (e.g., during a debris disposal operation or during return of flapper 170 to a stationary state). In some embodiments, an optional protective track cover 310 may be installed over at least a portion of guide track 300. In other embodiments, a stop may be provided along at least a portion of guide track 300 that restricts movement of rack 260 beyond a predetermined extent. An exemplary stop 312 is shown in FIG. 6D adjacent lower rack portion 260b and particularly at a junction where tines 280 join second yoke 282.

Rack and pinion assembly 225 is complemented by top pulley 272 that is rotatably supported by a top pulley bracket 270 depending from outer canister surface 106c′ adjacent undercarriage 244 of pull lever body 22. A bottom pulley 314 is rotatably supported by at least a portion of scaffold clutch 208 that serves as a bottom pulley bracket (for example, by a clutch finger 208a). Pulleys 272 and 314 operably support movement of a wire or cable 316 having an extent 316a secured to a pulley knob 319. Pulley knob 319 is rotatably supported by a pair of pulley mounts 321 depending from undercarriage 244 of pull lever body 232 (for example, by a knob 318 integral with the undercarriage). Wire 316 includes an opposed extent 316b secured to a finial 320 disposed in a bottom latch 322. A guide channel 324 may be defined along at least a portion of scaffold clutch 208 that permits unimpeded movement of wire 316 along a defined path. It is understood that wire 316 may comprise one or more wires, cables, ropes, belts, chains or complementary or equivalent structures.

Flapper support surface 172 incorporates a rail passage 330 within which bottom latch 322 is reciprocatingly disposed in cooperation with a stationary latch cover 328. Bottom latch 322 includes an internal wall 322a against which a finial head 320a is seated when flapper 170 is in a closed position (as shown in FIG. 5). Bottom latch 322 also includes a protruding lock tab 322b opposite internal wall 322a. Lock tab 322b includes an overhang 322b′ that extends over a ridge 350 in canister frame 140 at distal extent 140a thereof when flapper 170 is in a closed position. Lock tab 322b need not fully engage ridge 350, as evidenced by a slack distance Dₛ (see FIG. 6E). To ensure that bottom latch 322 is retractable along rail passage 330, a spring 352 is placed intermediate internal wall 322a and lock tab 322b. Spring 352 has hooked extents 352a, 352b for securing the spring to bottom latch 322 and to flapper 170. In an exemplary embodiment, hooked extent 352b may be detachably secured to a hanger 178b provided at or adjacent aperture 178b in flapper side wall 178. Spring 352 therefore biases bottom latch 322, and particularly locking tab 322b thereof, toward ridge 250 so that flapper 170 remains in a generally closed position when a disposal operation is not being performed.

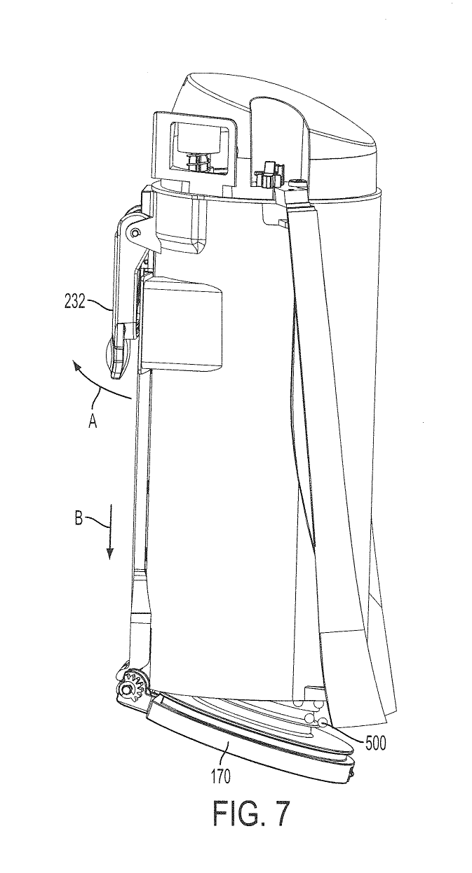

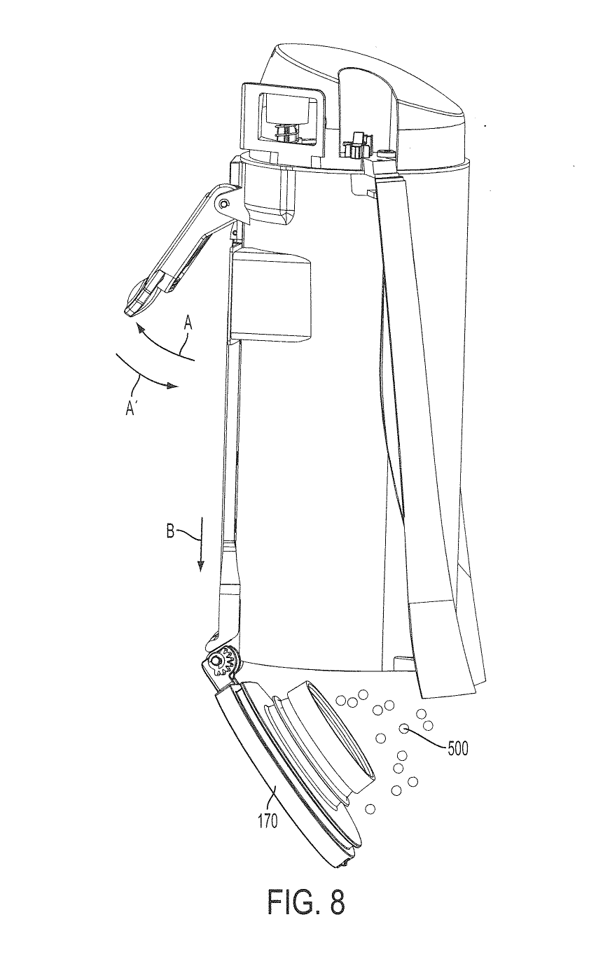

Upon lifting and lowering pull lever body 232, flapper 170 is actuatable among (1) a stationary state in which flapper 170 obstructs release of debris from coarse debris collection area 120 and fine debris collection area 130, such as when canister 106 is disposed in chamber 60 or during carrying of canister 106 prior to or following a debris disposal operation (see FIG. 5); (2) an articulating state in which flapper 170 traverses a controlled angular range of motion so as to at least partially release collected debris from the collective debris release outlet of the debris collection device (see released debris 500 of FIG. 7); and (3) a release state in which flapper 170 permits fall release of collected debris 500 from the collective debris release outlet of debris collection device 100 (see FIG. 8). When disposal of collected debris is required, a user grasps handle 102 of debris collection device 100 and removes the debris collection device from chamber 60. In embodiments where ribs 172b are in cooperating engagement with engagement teeth 68 in chamber seat 66, the debris collection device is removed from chamber 60 by applying a force that exceeds the retention force between the ribs and the engagement teeth. As previously disclosed, removal of debris collection device 100 from chamber 60 may also be effected by actuation of release buttons on handle 102 that effect retraction of corresponding pins from like recesses in chamber 60. Upon clearing debris collection device 100 from chamber 60, the user carries the debris collection device by handle 102 and transports the debris collection device to a waste receptacle (e.g., a dustbin, a trash bag, etc.).

At the onset of a disposal operation, a user positions flapper 170 (for instance, at a waste receptacle ingress) and lifts pull lever body 232 in the direction of arrow A (shown in FIG. 7) while holding dust bin assembly 100 by handle 102. Lifting of pull lever body 232 incurs rotation of hinge bracket 242 along undercarriage 244 and consequent translational motion of shaft 240 along apertures 238. Actuation gears 252 received by corresponding apertures 248 rotate in response to lifting of the pull lever body. As gear teeth 252 engage corresponding upper rack bifurcation teeth 264a, rotational motion translates into linear movement of rack 260 in a direction indicated by arrow B (see FIGS. 7 and 8). Linear movement of rack 260 effects corresponding engagement of pinion &tents with lower rack tine teeth 280a and corresponding rotation of flapper 170 along pinion joint 200.

Lifting of pull lever body 232 additionally imparts a pulling force on wire 316 sufficient to actuate pulleys 272, 314 and retract finial 320 in bottom latch 322. Retraction of finial 322 exerts a corresponding force on spring 352 sufficient to overcome the bias thereof. Locking tab 322b consequently retreats through aperture 178b of flapper side wall 178 and clears ridge 350 of canister frame 150. Flapper 170 instantaneously pivots from its stationary state into an articulating state until reaching the release state. In the release state, debris 500 collected in coarse debris collection area 120 and fine debris collection area 130 departs the collection areas for disposal (see FIG. 8). The biasing effect of spring 252 controls the tension realized by wire 316 such that flapper 170 remains in its release state until a user lowers pull lever body 232 in the direction of arrow A′ (see FIG. 8) toward canister outer surface 106c′. The extent of engagement of detents 202a with lower rank tine teeth 280a at least partially defines an outer angular extent to which flapper 170 rotates to realize the flapper's release state. An opposed extent of the flapper's angular range of motion is provided by the a predetermined slack distance Dₛ when flapper 170 is in its stationary state (as shown in FIG. 6E and further described herein). Therefore, when flapper 170 is in its articulation state, a plurality of angular ranges are realized along the flapper's path to the release state.

When pull lever body 232 is lowered, spring 326 biases bottom latch 322 forward through aperture 178b toward ridge 322b and translates finial 320 thereby. Movement of finial 320 and wire 316 in communication therewith effects rotation of detents 202a along lower rack tine teeth 280a as well as engagement of actuation gear teeth 252 with upper rack bifurcation teeth 264a. Reverse linear movement of rack 260 is thereby effected (in a direction opposite that indicated by arrow B in FIG. 8), and flapper 170 realizes its articulating state before returning to its stationary state. While flapper 170 is in the articulation state, a user can control the pressure applied to gripping extent 232a of pull lever body 232, thereby enabling control of the tension realized by flapper 170 and the flow rate of release of debris 500 through bottom open extent 106b. In all states of flapper 170, a user never needs to contact flapper 170 to control the release of debris or the flapper's degree of rotation. Lifting of pull lever body 232 realizes immediate release of debris 500 while controlled lowering of the pull lever body permits controlled articulation of flapper 170 until the flapper reaches its stationary state, all of which is performed without user contact with the flapper.

In the unlikely event that pull lever body 232 becomes inactive (e.g., wire 316 is unintentionally severed), it is contemplated that bottom latch 322 may be manually actuated as an emergency release. Tactile indicia such as a finger tab may be incorporated with bottom latch 322 to slide the bottom latch against the bias of spring 326 and release flapper 170 from its stationary state. Although in such a circumstance a user contacts bottom latch 322, this emergency release feature ensures that flapper 170 releases a fall extent of articulation, thereby obviating any need for a user to clear accumulated debris from the collective debris release outlet.

In embodiments where rack and pinion assembly 225 incorporates locking engagement between pull lever body 232 and rack 260 (as described herein with respect to an exemplary embodiment), initial lifting of pull lever body 232 can effect initial release of the pull lever body from the rack prior to translation of linear movement to the rack. In such exemplary embodiments, a user lifts pull lever body 232 in the direction of arrow A (shown in FIGS. 7 and 8) to release the engagement between the pull lever body and the rack. Engagement release may be confirmed by one or more of audible, visual and tactile indicia as described herein. Once the release of the locking engagement is confirmed, a user is assured that flapper 170 will readily enter its articulating state upon simple continued lifting of pull lever body 232 without additional manipulation of the flapper (e.g., by hand). A user will likewise infer that controlled lowering of pull lever body 232 correspondingly controls the degree of articulation realized by flapper 170 relative to open bottom canister extent 106b. Pull lever body 232 can be lowered until locking engagement between the pull body and rack 260 is again effected (as confirmed by one or more indicia as described herein).

In some embodiments, incorporation of slack distance Dₛ as shown and described herein obviates the need for superfluous structure to ensure articulation of flapper 170 upon actuation of pull lever body 232. Such slack distance is maintained without the need for additional sealing structure, since debris collection device 100 exhibits a tight seal when canister 106 is seated in chamber 60. This seal is at least attributable to engagement of annular 172a by chamber seat 66 when debris collection device 100 is seated in chamber 60. The weight of debris collection device 100 is borne by ribs 172a upon chamber seat 66, thereby sealing flapper 170 against bottom open extent 106a of canister 106 to ensure closure of the interface 182 therebetween. The user is therefore always assured that, even if flapper 170 is not entirely closed prior to placement in main body 12, not only will collected particulates remain within canister 106, but also flapper 170 will provide a secure interface against the open bottom extent of the debris collection device after placement in main body 12.

This sealing capability obviates the need for additional structure to ensure a proper seal when canister 106 is removed from chamber 60. Consequently, upon first lifting pull lever body 232 and retracting locking tab 322b, gravity takes immediate effect on flapper 170 and flapper 170 immediately falls to the extent that rack 260 and pinions 202 take control. Further lifting of pull lever body 232 correspondingly actuates rack and pinion assembly 225 to realize controlled articulation of flapper 170 among a plurality of intermediate positions (e.g., as shown in FIG. 7). It is therefore the gravitational effect upon flapper 170, imparted by at least its own weight and also by the weight of debris (collected in the collective debris collection area provided by coarse debris collection area 120 and fine debris collection area 130) that achieves articulation of flapper 170. The nature of a rack and pinion configuration ensures that a degree of slack (also referred to as “slop”) exists between bottom open extent 106b and flapper 170, as realized by predetermined slack distance Dₛ. Such clearance may be determined by the tolerance of the bottom latch. In some embodiment, the interface distance between the flapper seat and the seat of the bottom open extent of the canister (see interface 182) is about equal to the slack distance between the flapper latch and the ridge. The cumulative distance of these two distances may collectively be considered the slack distance. In exemplary embodiments, this collective slack distance may be less than or equal to about 1 mm.

Thus, the seal force at the interface between bottom open extent 106a and flapper seat 180 is less than the force of gravity to ensure that flapper 170 changes state in concert with actuation of pull lever 232. Successful operation of debris collection device 100, while not entirely dependent on full closure of flapper 170 by rack and pinion assembly 225, ensures a sufficient seal to prevent air leakage through interface 182. The total articulation range of flapper 170 can therefore be controlled, for example, by the tension exerted by wire 316 upon initial release of flapper 170 and also during a full range of rotation exhibited by the flapper when pull lever body 232 returns to a stationary orientation adjacent outer canister wall 106c′. Debris canister 106 can be configured such that, when it is engaged into an operational state within main body 12, such positioning can result in disposition of flapper 170 against seat 66. Such positioning can ensure a sufficient state for the proper operation of cleaning apparatus 10 to allow the cyclonic separator to effectively receive enough airflow and separate debris therefrom.

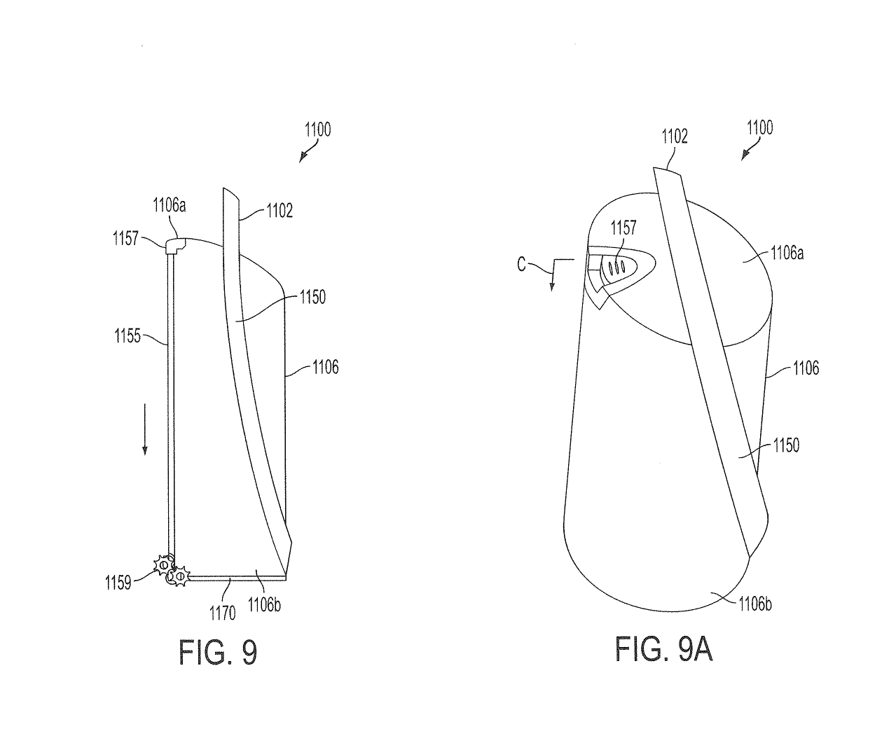

Now referring to FIGS. 9 to 13A, alternative exemplary embodiments of debris collection cup assemblies are provided that incorporate a controlled tension feature for the release of debris. It is contemplated that each such debris collection device incorporates a centrifugal separation system therein as described hereinabove with respect to canister 106. It is understood that any of the debris collection cup assemblies shown and described herein with respect to FIGS. 9 to 13A may include multiple planar linkages with one or more gear assemblies.

FIGS. 9 and 9A show an exemplary debris collection device 1100 having a handle 1102 for carrying a canister 1106 having a frame 1150. A linkage rod 1155 is provided that establishes operable communication between a release button 1157 provided at a handle extent 1106a of canister 1106 and mating gears 1159 disposed at an opposed flapper extent 1106b. Forwardly directed pressure placed upon release button 1157 discharges the release button from a locked position (e.g., when canister 1106 is seated in a main body chamber such as chamber 60). Subsequent depression of release button 1157 (see arrow C in FIG. 9A) engages linkage rod 1155 to actuate gears 159 and consequently actuate a flapper 1170 relative to flapper extent 1106b of canister 1106.

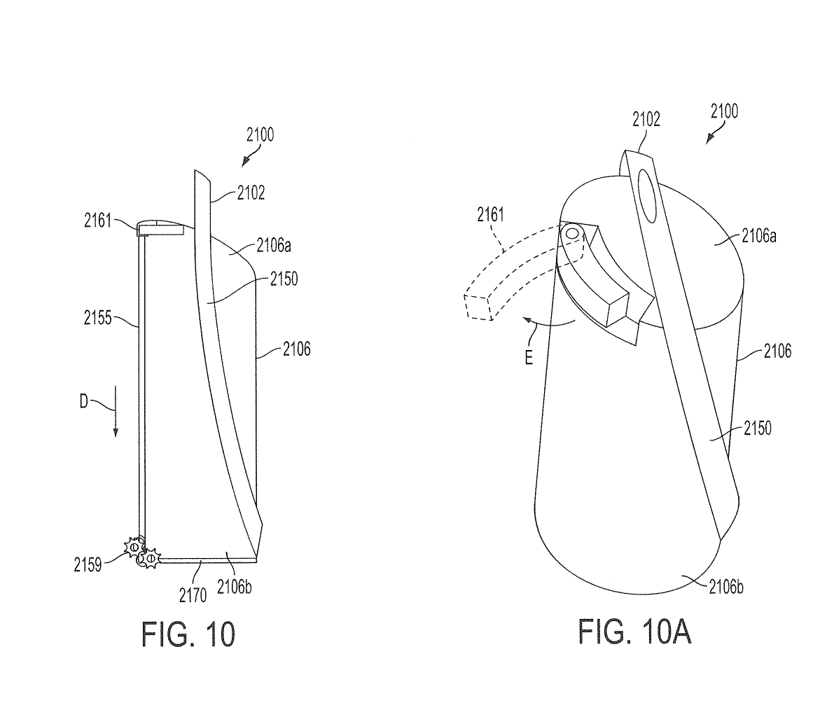

Referring to FIGS. 10 and 10A, another exemplary debris collection device 2100 is provided having a handle 2102 for carrying a canister 2106 having a frame 2150. Debris collection device incorporates a linkage rod 2155 and mating gears 2159 similar to those provided with respect to the embodiment of FIGS. 9 And 9A. Linkage rod 2155 establishes operable communication between a lever 2161 provided at a handle extent 2106a of canister 2106 and mating gears 2159 disposed at an opposed flapper extent 2106b. Linkage rod 2155 moves downwardly (e.g., in the direction of arrow D shown in FIG. 1) relative to canister 2106 by turning lever 2161 outwardly of handle extent 2106a (see arrow E in FIG. 10A). Downward movement of linkage rod 2161 actuates gears 2159 and actuates flapper 2170 thereby.

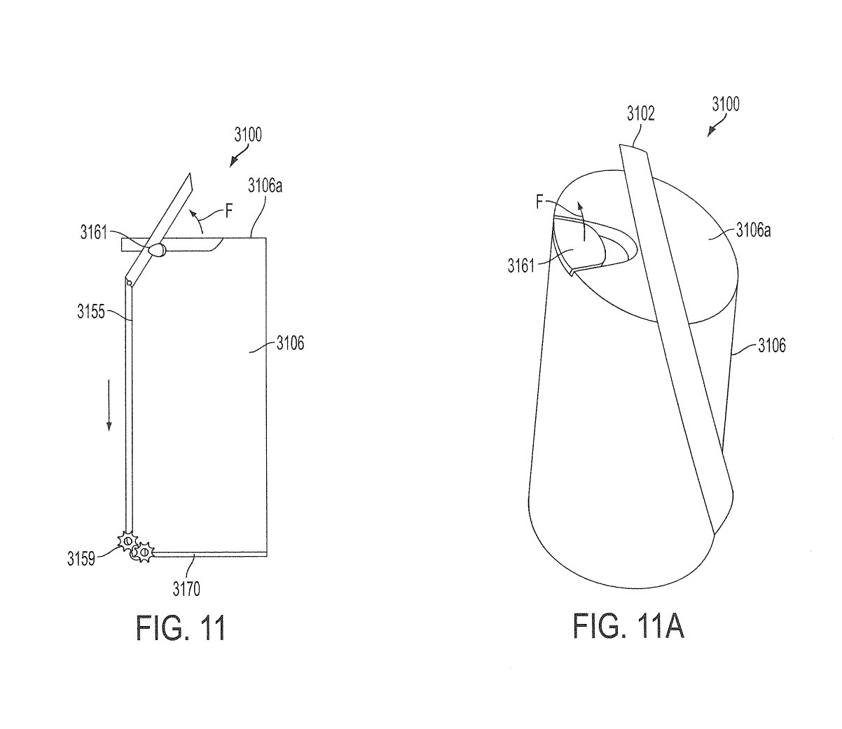

Now referring to FIGS. 11 and 11A, yet another exemplary debris collection device 3100 is provided having a handle 3102 for carrying a canister 3106. A dual linkage assembly is provided that includes a linkage rod 3155, mating gears 3159 and articulating lever 3161 disposed at a handle extent 3106a of canister 1306. By lifting lever 3161 upwardly away from handle extent 3106a (see arrow F in FIG. 11A), linkage rod 3155 actuates gears 3159 and actuates flapper 3170.

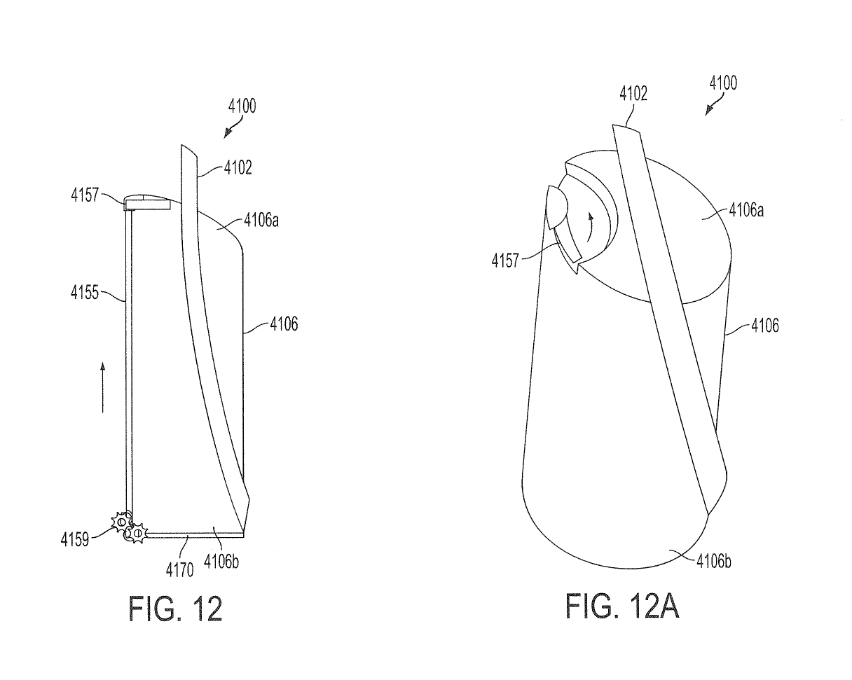

FIGS. 12 and 12A provide an exemplary debris collection device 4100 having a handle 4102 for carrying a canister 4106. A cable 4155 operatively connects a lever 4157 that is disposed at a handle extent 4106a of canister 4106 with matching gears 4159 disposed at an opposed flapper extent 4106b. Rotation of lever 4157 along handle extent 4106a (for example, in a counterclockwise rotation as shown in FIG. 12A) engages cable 4155 and correspondingly actuates gears 4159. Continued rotation of lever 4155 causes gears 4159 to actuate flapper 4170 in a controlled manner. Although lever 4157 is shown as being rotated in a counterclockwise manner, it is understood that lever 4157 may be rotated in a clockwise orientation to effect a similar operation of debris collection device 4100.

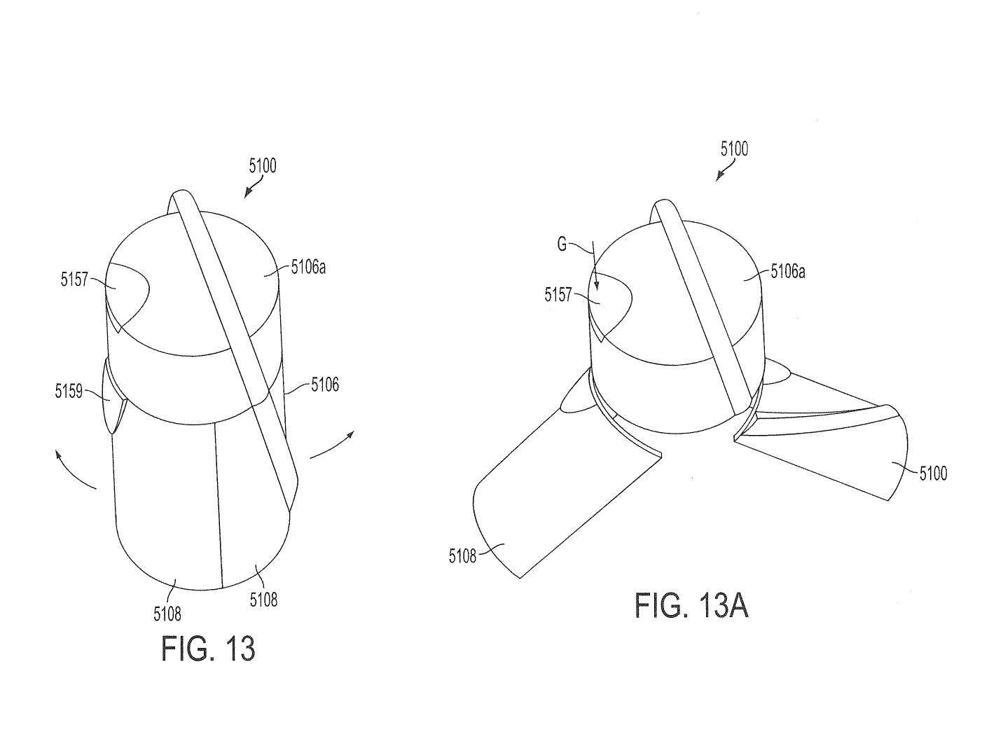

FIGS. 13 and 13A provide an exemplary debris collection device 5100 having a canister 5106 incorporating mating clamshell halves 5108. Depression of an actuation button 5157 on a handle extent 5106a (see arrow G in FIG. 13A) engages geared linkage assembly 5159 and actuates both clamshell halves 5108 for release of collected particulates from the canister. Linkage assembly 5159 may be configured so as to effect simultaneous actuation of clamshell halves 5108. Linkage assembly may be alternatively configured to effect offset actuation of the clamshell halves (e.g., to articulate one clamshell half prior to articulation of the second clamshell half so as to control the flow rate of debris from debris collection device 5100).

The presently disclosed invention is amenable for use with other vacuum cleaner types, including but not limited to other upright vacuum cleaner configurations, hand-held vacuums, central particulate cleaner systems, steam cleaners, wet and wet-dry vacuums, and equivalent and complementary devices.

As used herein, a “user” or an “operator” may be a single user or operator or multiple users and operators (for example, multiple users within a shared residence or multiple members of a cleaning service sharing use of one or more devices incorporating the presently disclosed invention). As used herein, the term “process” or “method” may include one or more steps performed at least by one user or operator. Any sequence of steps is exemplary and is not intended to limit methods described herein to any particular sequence, nor is it intended to preclude adding steps, omitting steps, repeating steps, or performing steps simultaneously.

The dimensions and values disclosed herein are not to be understood as being strictly limited to the exact numerical values recited. Instead, unless otherwise specified, each such dimension is intended, to mean both the recited value and a functionally equivalent range surrounding that value as well as equivalent units of that value. For example, a dimension disclosed as “40 mm” is intended to mean “about 40 mm” as well as “1.58 inches”. The disclosure of such dimensions and values, however, shall not preclude use of any of disclosed devices having dimensions and values outside of the prescribed ranges.

Every document cited herein, including any cross-referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While the presently disclosed invention has been described in a preferred form, it will be understood that changes, additions, and modifications may be made to the respective articles forming the invention. Accordingly, no limitation should be imposed on the scope of this invention, except as set forth in the accompanying claims.

1-21. (canceled)

22. A vacuum cleaner comprising:
a base suction unit;
an apparatus handle; and
a main body having a debris collection device removably secured to the main body, the debris collection device including,
a debris collection canister within which debris accumulates;
a handle located on the debris collection canister;
an actuatable flapper located adjacent a collective debris release outlet from which accumulated debris is released from the debris collection canister; and
a controlled tension apparatus that controls an angular range of movement of the flapper.

23. The vacuum cleaner of claim 22, wherein the controlled tension apparatus is operable to open the flapper for controllable release of the accumulated debris from the collective debris release outlet.

24. The vacuum cleaner of claim 23, wherein the controlled tensions apparatus is operable to close the flapper.

25. The vacuum cleaner of claim 22, wherein the debris collection canister includes a debris collection cover.

26. The vacuum cleaner of claim 22, wherein the controlled tension apparatus controls actuation of the flapper between,
a stationary state in which the flapper obstructs release of debris from the debris collection canister;
an articulating state in which the flapper traverses a controlled angular range of motion so as to at least partially release debris from the debris collection canister; and
a release state in which the flapper permits full release of accumulated debris from the debris collection canister.

27. The vacuum cleaner of claim 22, wherein the debris collection canister accommodates a centrifugal separation system.

28. The vacuum cleaner of claim 27, wherein the centrifugal separation system and the debris collection canister together define a coarse debris collection area and a fine debris collection area.

29. The vacuum cleaner of claim 28, further comprising a restrictor positioned intermediate the cyclonic separation system and an interior surface wall of the debris collection canister and configured to inhibit backflow of debris from the coarse debris collection area.

30. The vacuum cleaner of claim 22, wherein the flapper includes a support surface having one or more annular ribs that support a combined weight of the debris collection device and any debris collected in the debris collection canister.

31. The vacuum cleaner of claim 22, wherein the flapper includes a pedestal having a generally cylindrical side wall depending upwardly from a generally planar floor, with the floor having a collection surface upon which debris accumulates in a coarse debris collection area, and the pedestal terminating in an upper wall extent that cooperates with a fine debris release outlet for releasing the debris accumulated in a fine debris collection area when the flapper is in a stationary state in which the flapper obstructs release of debris from the debris collection canister.

32. The vacuum cleaner of claim 22, wherein the flapper includes a generally annular side wall coextensive with a flapper support surface and a flapper seat, with the flapper seat providing a predetermined clearance between the flapper and the collective debris release outlet when the flapper is in a stationary state in which the flapper obstructs release of debris from the debris collection canister.

33. The vacuum cleaner of claim 22, wherein the flapper includes a generally annular groove that is provided intermediate a generally planar floor and a flapper seat and facilitates insertion and operation of a seal member.

34. The vacuum cleaner of claim 22, wherein the flapper includes a pinion joint depending from a flapper side wall that effects rotatable coupling of the flapper with the debris collection canister, with the pinion joint including one or more pinions and with each pinion having a plurality detents.

35. The vacuum cleaner of claim 34, wherein the flapper includes an aperture incorporated in the flapper side wall opposite the pinion joint and being generally dimensioned for sliding receipt of a flapper latch that is reciprocatingly disposed along a flapper support surface.

36. The vacuum cleaner of claim 35, wherein the controlled tension apparatus comprises a pulley system operable with a wire having an extent rotatably supported adjacent a pull lever and an opposed extent secured to a finial disposed in the flapper latch.

37. The vacuum cleaner of claim 35, wherein the flapper latch includes an internal wall against which a finial head is seated when the flapper is in a stationary state in which the flapper obstructs release of debris from the debris collection canister.

38. The vacuum cleaner of claim 37, wherein the flapper latch further includes a protruding lock tab opposite the internal wall of the flapper latch, with the lock tab including an overhang that extends over a ridge in the debris collection canister when the flapper is in the stationary state, with the lock tab and the ridge having a predetermined slack distance therebetween.

39. The vacuum cleaner of claim 35, further comprising a biasing spring having opposed engagement extents for releasably securing the spring to the flapper latch and the flapper so that the spring urges the flapper into a stationary state in which the flapper obstructs release of debris from the debris collection canister.

40. The vacuum cleaner of claim 22, wherein the flapper includes one or more complementary ribs that depend from a flapper support surface and releasably engage corresponding engagement structure provided in the chamber of the main body.

41. The vacuum cleaner of claim 22, wherein the controlled tension apparatus includes a rack and pinion assembly that operably joins the flapper to a manually liftable pull lever such that manipulation of the pull lever effects corresponding actuation of the flapper relative to the collective debris release outlet.

42. The vacuum cleaner of claim 41, wherein the pull lever is in operable communication with a pull lever body having a gripping portion that can be readily grasped by a user and an opposed mounting portion for mounting of the pull lever body to the debris collection canister.

43. The vacuum cleaner of claim 41, wherein the pull lever includes a pair of actuation arms extending from a shoulder and terminating in free arm extents, with each actuation arm having a longitudinal aperture that accommodates slidable engagement with a pull lever shaft when the pull lever is actuated relative to the debris collection canister.

44. The vacuum cleaner of claim 41, wherein the rack and pinion assembly further comprises at least one actuation gear having a plurality of gear teeth engageable with one or more recessed actuation teeth provided in an actuation gear aperture defined at each free arm extent.

45. The vacuum cleaner of claim 41, wherein the rack and pinion assembly includes a rack having an elongate rack body interposed between an upper rack portion and a lower rack portion, the lower rack positioned adjacent the collective debris release outlet.

46. The vacuum cleaner of claim 45, wherein the upper rack portion comprises bifurcations joined by a first yoke, with each bifurcation having a predetermined length along which a plurality of teeth protrude in general linear alignment and correspondingly engage with one more actuation gear teeth on an actuation gear when the pull lever is lifted; and
the lower rack portion comprises a pair of tines joined by a second yoke, with each tine having a predetermined length along which a plurality of teeth protrude in general linear alignment and correspondingly engage one or more detents on a pinion when the flapper is coupled to the debris collection canister.

47. The vacuum cleaner of claim 22, further comprising a locking appliance configured to prevent inadvertent release of accumulated debris.

48. The vacuum cleaner of claim 47, wherein the locking appliance is provided on at least one of a pull lever body and a rack.

49. A vacuum cleaner, comprising:
a base suction unit;
an apparatus handle; and
a main body provided intermediate the base suction unit and the apparatus handle and having a debris collection device removably secured to the main body, the debris collection device including,
a debris collection canister that accommodates a centrifugal separation system and, together with the centrifugal separation system, defines a coarse debris collection area and a fine debris collection area within which debris accumulates;
a debris collection cover coupled with the debris collection canister;
a handle located on at least one of the debris collection canister and the debris collection cover;
an actuatable flapper adjacent a collective debris release outlet from which accumulated debris is released from the coarse debris collection area and the fine debris collection area; and
a controlled tension apparatus that controls an angular range of movement of the flapper for controllable release of accumulated debris from the collective debris release outlet.
